(19) United States
(12) Patent Application Publication
(10) Pub. No.: US 2025/0391000 A1
(43) Pub. Date: Dec. 25, 2025

(54) ELECTRONIC DEVICE, METHOD, AND COMPUTER-READABLE STORAGE MEDIUM COMPRISING PLURALITY OF CAMERAS

(71) Applicant: Samsung Electronics Co., Ltd., Suwon-si (KR)

(72) Inventors: Hongsuk CHOI, Suwon-si (KR); Hyunhee PARK, Suwon-si (KR); Jaehyoung PARK, Suwon-si (KR); Sejun SONG, Suwon-si (KR); Jeongyeol LEE, Suwon-si (KR)

(21) Appl. No.: 19/086,593

(22) Filed: Mar. 21, 2025

Related U.S. Application Data
(63) Continuation of application No. PCT/KR2025/099714, filed on Mar. 12, 2025.

(30) Foreign Application Priority Data
Jun. 21, 2024 (KR) 10-2024-0081452
Aug. 14, 2024 (KR) 10-2024-0109246

(51) Int. Cl. G06T 5/80; G06T 5/60; H04N 23/63; H04N 23/698; H04N 23/90

(52) U.S. Cl. CPC G06T 5/80; G06T 5/60; H04N 23/632; H04N 23/698; H04N 23/90

(57) ABSTRACT

An electronic device includes memory, including one or more storage mediums, storing instructions, a first camera having a first field of view, a second camera having a second field of view, wherein the second camera and the first camera are disposed on a same side of the electronic device to face in a same direction, a display, and at least one processor including processing circuitry, wherein the instructions, when executed by the at least one processor individually or collectively, cause the electronic device to, based on receiving an input for obtaining an image using the first camera, control the first camera and the second camera to obtain a first image and a second image, obtain a third image, by compensating for a peripheral area of the obtained first image using the obtained second image, and store, in the memory, the third image.

### CROSS-REFERENCE TO RELATED APPLICATION(S)

This application is a continuation application, claiming priority under 35 U.S.C. § 365 (c), of an International application No. PCT/KR2025/099714, filed on Mar. 12, 2025, which is based on and claims the benefit of a Korean patent application number 10-2024-0081452, filed on Jun. 21, 2024, in the Korean Intellectual Property Office, and of a Korean patent application number 10-2024-0109246, filed on Aug. 14, 2024, in the Korean Intellectual Property Office, the disclosure of each of which is incorporated by reference herein in its entirety.

### TECHNICAL FIELD

The disclosure relates to an electronic device, a method, and a non-transitory computer-readable storage medium including a plurality of cameras.

### BACKGROUND ART

An electronic device may include a plurality of cameras. For example, the plurality of cameras may have different field of views (FOVs). For example, the electronic device may obtain images using the plurality of cameras.

The above information is presented as background information only to assist with an understanding of the disclosure. No determination has been made, and no assertion is made, as to whether any of the above might be applicable as prior art with regard to the disclosure.

### DISCLOSURE

Aspects of the disclosure are to address at least the above-mentioned problems and/or disadvantages and to provide at least the advantages described below. Accordingly, an aspect of the disclosure is to provide an electronic device, a method, and one or more non-transitory computer-readable storage media including a plurality of cameras.

Additional aspects will be set forth in part in the description which follows and, in part, will be apparent from the description, or may be learned by practice of the presented embodiments.

### Technical Solution

In accordance with an aspect of the disclosure, an electronic device is provided. The electronic device includes memory, comprising one or more storage mediums, storing instructions, and at least one processor comprising processing circuitry. The electronic device may comprise a first camera having a first field of view (FOV), a second camera having a second FOV wider than the first FOV, wherein the second camera and the first camera are disposed on a same side of the electronic device to face in a same direction, a display, and the at least one processor comprising processing circuitry. The instructions may, when executed by the at least one processor individually or collectively, cause the electronic device to receive an input for obtaining an image through the first camera. The instructions may, when executed by the at least one processor individually or collectively, cause the electronic device to, based on the input, control the first camera to obtain a first image. The instructions may, when executed by the at least one processor individually or collectively, cause the electronic device to, based on the input, control the second camera to obtain a second image. The instructions may, when executed by the at least one processor individually or collectively, cause the electronic device to obtain a third image, by compensating for a peripheral area of the first image using the second image. The instructions may, when executed by the at least one processor individually or collectively, cause the electronic device to store, in the memory, the third image.

In accordance with another aspect of the disclosure, a method may be performed in an electronic device including memory, comprising one or more storage mediums, storing instructions, a first camera having a first field of view (FOV), a second camera having a second FOV wider than the first FOV, wherein the second camera and the first camera are disposed on a same side of the electronic device to face in a same direction, and a display. The method may comprise receiving an input for obtaining an image through the first camera. The method may comprise, based on the input, controlling the first camera to obtain a first image. The method may comprise, based on the input, controlling the second camera to obtain a second image. The method may comprise obtaining a third image, by compensating for a peripheral area of the first image using the second image. The method may comprise storing, in the memory, the third image.

In accordance with another aspect of the disclosure, A non-transitory computer readable storage medium is described. The non-transitory computer readable storage medium may store one or more programs. The one or more programs may comprise instructions which, when executed by an electronic device comprising memory, comprising one or more storage mediums, storing instructions, a first camera having a first field of view (FOV), a second camera having a second FOV wider than the first FOV, wherein the second camera and the first camera are disposed on a same side of the electronic device to face in a same direction, and a display, cause the electronic device to receive an input for obtaining an image through the first camera. The one or more programs may comprise instructions which, when executed by the electronic device, cause the electronic device to, based on the input, control the first camera to obtain a first image. The one or more programs may comprise instructions which, when executed by the electronic device, cause the electronic device to, based on the input, control the second camera to obtain a second image. The one or more programs may comprise instructions which, when executed by the electronic device, cause the electronic device to obtain a third image, by compensating for a peripheral area of the first image using the second image. The one or more programs may comprise instructions which, when executed by the electronic device, cause the electronic device to store, in the memory, the third image.

Other aspects, advantages, and salient features of the disclosure will become apparent to those skilled in the art from the following detailed description, which, taken in conjunction with the annexed drawings, discloses various embodiments of the disclosure.

### DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of obtaining images using a plurality of cameras;

FIG. 2 illustrates an example of a deteriorated characteristic caused in a peripheral area of an image obtained using a camera;

FIG. 3 is a simplified block diagram of an electronic device;

FIG. 4 is a flowchart illustrating exemplary operations of an electronic device for obtaining an image compensated for a deteriorated characteristic;

FIG. 5A illustrates an example of a partial image of a second image corresponding to a peripheral area of a first image including a periphery of the first image;

FIG. 5B illustrates a chart representing a change in a distortion amount according to an area of a lens;

FIG. 5C illustrates a chart representing a change in relative illumination according to an area of a lens;

FIG. 6 illustrates an example of executing a model to obtain an image compensated for a deteriorated characteristic;

FIG. 7 illustrates an example of an image in which a deteriorated characteristic is compensated;

FIG. 8 is a flowchart illustrating exemplary operations of an electronic device for obtaining a set of a plurality of images compensated for a deteriorated characteristic;

FIG. 9A illustrates an example of a set of a plurality of images obtained using a first camera and a partial image of an image obtained using a second camera;

FIG. 9B illustrates an example of executing a model to obtain a set of a plurality of images compensated for a deteriorated characteristic;

FIG. 10 is a flowchart illustrating exemplary operations of an electronic device to obtain a video including an image compensated for a deteriorated characteristic;

FIG. 11A illustrates an example of a set of a plurality of images obtained using a first camera, and partial images of a set of a plurality of images obtained using a second camera;

FIG. 11B illustrates an example of executing a model to obtain a video including an image compensated for a deteriorated characteristic;

FIG. 12 illustrates an example of displaying a preview image compensated for a deteriorated characteristic;

FIG. 13 illustrates an example of a user input for switching a mode;

FIG. 14 illustrates an example of obtaining an image with improved image quality;

FIG. 15 is a block diagram of an electronic device in a network environment according to various embodiments;

FIG. 16 is a block diagram illustrating a camera module according to various embodiments; and

FIG. 17 is a schematic diagram of an artificial intelligence (AI) system.

Throughout the drawings, it should be noted that like reference numbers are used to depict the same or similar elements, features, and structures.

### MODE FOR INVENTION

Hereinafter, embodiments of a present disclosure will be described in detail with reference to drawings so that those having ordinary knowledge in the art to which the present disclosure belongs may easily implement the present disclosure. However, the present disclosure may be implemented in several different forms and is not limited to the embodiment described herein. With respect to the description of the drawing, the same or similar reference mark may be used for the same or similar component. In addition, in the drawing and the related description, descriptions of a well-known function and a configuration may be omitted for clarity and brevity.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

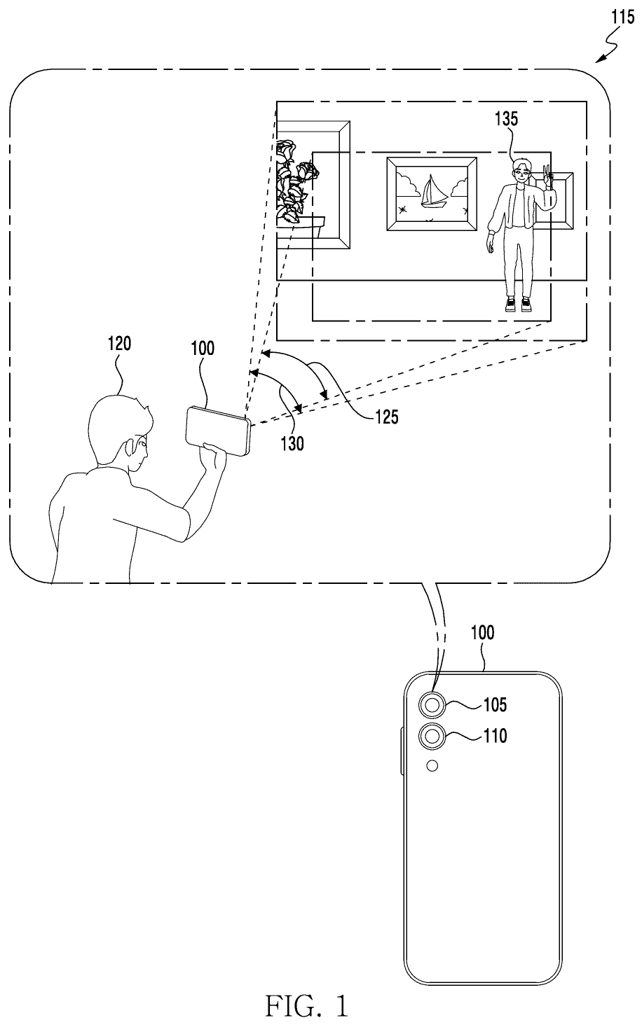

FIG. 1 illustrates an example of obtaining images using a plurality of cameras.

Referring to FIG. 1, an electronic device 100 may be described as a device usable for obtaining an image. For example, the electronic device 100 may be one of various types of mobile devices, such as smartphones (e.g., a bar type smartphone, a foldable type smartphone, or a rollable type smartphone), a tablet, a wearable device, a cellular phone, a laptop, and/or other similar computing devices, having various form factors including circuits (or circuitry) for providing an operation of obtaining the image.

For example, the electronic device 100 may include a plurality of cameras (e.g., a first camera 105 and a second camera 110). For example, the plurality of cameras may be used to obtain the image. For example, the first camera 105 may be positioned on a side of the electronic device 100. For example, the second camera 110 may be positioned on the side of the electronic device 100 on which the first camera 105 is positioned, toward a direction in which the first camera 105 faces. For example, the first camera 105 and the second camera 110 may be positioned vertically adjacent to each other on a side of the electronic device 100, or, although not illustrated in FIG. 1, the first camera 105 and the second camera 110 may be positioned horizontally adjacent to each other on a side of the electronic device 100.

For example, the first camera 105 may be described as a wide angle camara. For example, the second camera 110 may be described as an ultrawide angle camera. For example, the first camera 105 and the second camera 110 may include cameras having a different field of view, other than the wide angle camera and the ultrawide angle camera, or cameras having a different deteriorated characteristic (e.g., distortion) for a same area in images obtained from each of the first camera 105 and the second camera 110. For example, the first camera 105 may have a first field of view (FOV) 125. For example, the second camera 110 may have a second field of view 130. For example, the second field of view 130 may be wider than the first field of view 125. For example, as the second camera 110 is positioned on a side of the electronic device 100 on which the first camera 105 is positioned, toward a direction in which the first camera 105 faces, the first field of view 125 may overlap the second field of view 130. For example, the second camera 110 and the first camera 105 may be disposed on the same side of the electronic device 100 to face the same direction.

For example, a state 115 may be described as a state in which a user 120 shoots a subject 135. For example, in the state 115, in case of shooting the subject 135 using the first camera 105 and the second camera 110, the electronic device 100 may obtain a plurality of images for the subject 135.

For example, the electronic device 100 may obtain a first image using the first camera 105. For example, the electronic device 100 may obtain a second image using the second camera 110. For example, as the first camera 105 includes a first lens having the first field of view 125, which is narrower than the second field of view 130, and overlaps in the second field of view 130, a scene represented in the first image may be included in a scene represented in the second image.

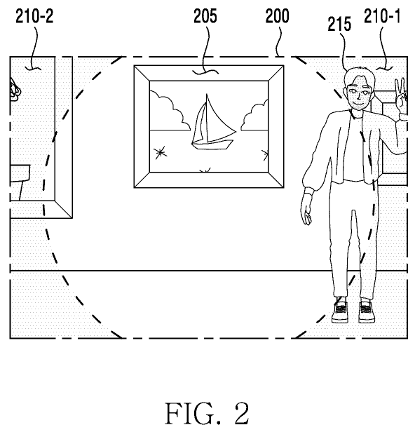

For example, an image obtained using the wide angle camera (e.g., the first camera 105) or the ultrawide angle camera (e.g., the second camera 110) may include a deteriorated characteristic. The deteriorated characteristic included in the image obtained using the wide angle camera (e.g., the first camera 105) or the ultrawide angle camera (e.g., the second camera 110) will be exemplified in a description of FIG. 2.

FIG. 2 illustrates an example of a deteriorated characteristic caused in a peripheral area of an image obtained using a camera.

Referring to FIG. 2, a deteriorated characteristic may be included in an image 200 obtained using a wide angle camera (e.g., a first camera 105). For example, the deteriorated characteristic in the image 200 may be caused in a peripheral area 210-1 or 210-2 of the image 200, including a periphery of the image 200.

For example, the deteriorated characteristic may be caused by refraction of light introduced from the outside through a first lens of the first camera 105. For example, as the refraction of the light increases toward a periphery of the lens, the peripheral area 210-1 or 210-2 of the image 200 including the periphery of the image 200 may have more deteriorated characteristic than a central area 205 of the image 200. For example, the deteriorated characteristic of the image 200 may include distortion of the image 200, a characteristic according to relatively low relative illumination, and/or relatively low quality of the image 200.

For example, a subject 215 (e.g., the subject 135 of FIG. 1) positioned in the peripheral area 210-1 or 210-2 of the image 200 including the periphery of the image 200 may appear stretched or darkened to a user by distortion caused in the peripheral area 210-1 or 210-2 of the image 200 including the periphery of the image 200. For example, as the subject 215 positioned in the peripheral area 210-1 or 210-2 of the image 200 including the periphery of the image 200 appears stretched or darkened, the user may feel discomfort. For example, a method for addressing the discomfort of the user due to distortion generated at the periphery of the image 200 may be required.

For example, in order to address this discomfort, an electronic device 100 may compensate for distortion caused in the peripheral area 210-1 or 210-2 of the image 200 including the periphery of the image 200. For example, an image obtained using a second camera 110 may be used to compensate for the distortion caused in the peripheral area 210-1 or 210-2 of the image 200 including the periphery of the image 200. For example, the electronic device 100 may change or reduce the distortion of the peripheral area 210-1 or 210-2 of the image 200 using the image obtained using the second camera 110.

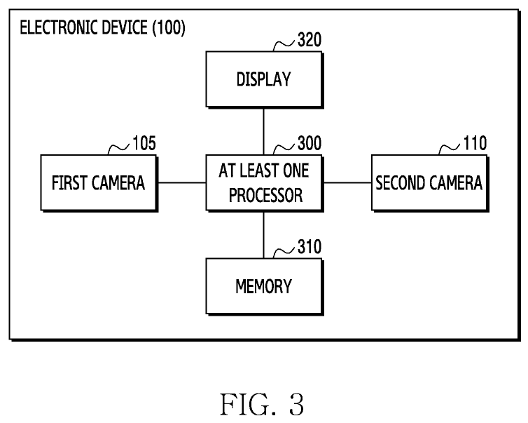

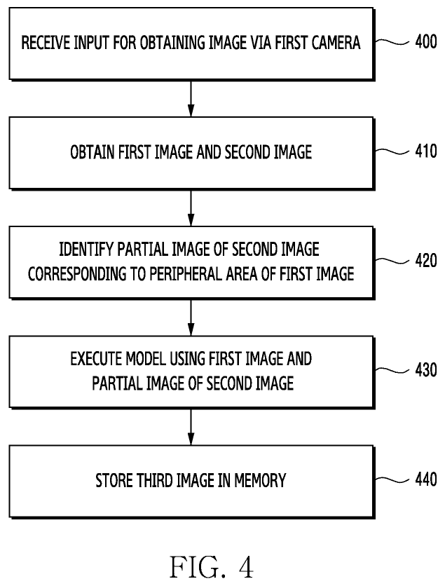

The electronic device 100 may execute operations to be exemplified in a description of FIGS. 4 to 13 to compensate for the distortion caused in the peripheral area 210-1 or 210-2 of the image 200 including the periphery of the image 200. The electronic device 100 may include components for executing the operations. The components may be exemplified in a description of FIG. 3.

FIG. 3 is a simplified block diagram of an electronic device.

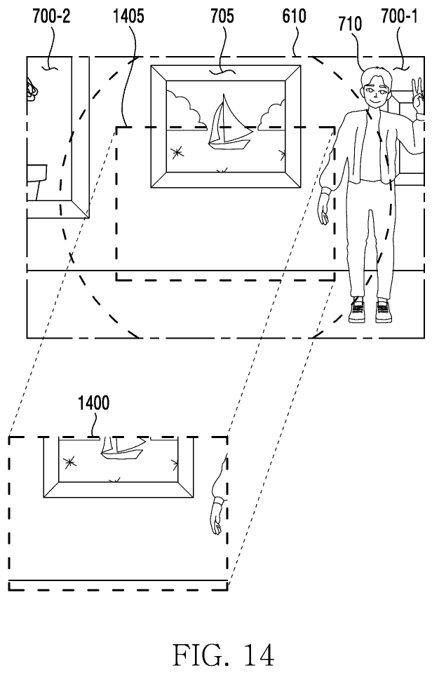

Referring to FIG. 3, an electronic device 100 may be one of various types of mobile devices, such as smartphones (e.g., a bar type smartphone, a foldable type smartphone, or a rollable type smartphone), a tablet, a wearable device, a cellular phone, a laptop, and/or other similar computing devices having various form factors. For example, the electronic device 100 may include the electronic device 100 of FIG. 1 or may correspond to the electronic device 100 of FIG. 1. For example, the electronic device 100 may include at least a portion of an electronic device 1401 of FIG. 14, or may correspond to at least a portion of the electronic device 1401 of FIG. 14. For example, the electronic device 100 may include at least one processor 300, memory 310, a display 320, a first camera 105, and a second camera 110.

The at least one processor 300 may include processing circuitry. For example, the at least one processor 300 may include a central processing unit (CPU) (e.g., including the processing circuitry). For example, the at least one processor 300 may include a graphic processing unit (GPU) (e.g., including the processing circuitry) and/or a neural processing unit (NPU) (e.g., including the processing circuitry). For example, the at least one processor 300 may be described as an application processor. For example, the at least one processor 300 may be configured to control the memory 310, the display 320, the first camera 105, and the second camera 110. The at least one processor 300 may be configured to execute instructions stored in the memory 310 individually or collectively to cause the electronic device 100 to perform at least some of the operations exemplified in the description of FIGS. 1 and 2. The at least one processor 300 may be configured to execute instructions stored in the memory 310 to cause the electronic device 100 to perform at least some of operations exemplified in a description of FIGS. 4 to 14.

The memory 310 may include one or more storage mediums. For example, the memory 310 may store various data used by at least one component (e.g., the at least one processor 300, the display 320, the first camera 105, and/or the second camera 110) of the electronic device 100. For example, the data may include input data or output data for software and related command. The memory 310 may include volatile memory or nonvolatile memory.

The display 320 may include a touch sensor set to detect a touch, or a pressure sensor set to measure intensity of a force generated by the touch. For example, the display 320 may be configured to display a preview image. For example, the display 230 may be configured to receive an input for obtaining an image using the first camera 105, while the preview image is displayed.

The first camera 105 may be configured to obtain an image. For example, the first camera 105 may be described as a wide angle camera. For example, the first camera 105 may have a first field of view (e.g., the first field of view 125 of FIG. 1). For example, the first camera 105 may be positioned on a side of the electronic device 100. As a non-limiting example, the first field of view may include a diagonal field of view of the first camera 105.

The second camera 110 may be configured to obtain an image. For example, the second camera 110 may be described as an ultrawide angle camera. For example, the second camera 110 may have a second field of view (e.g., the second field of view 130 of FIG. 1). For example, the second field of view may be wider than the first field of view. For a non-limiting example, the second field of view may be 1.3 times or more wider than the first field of view. As a non-limiting example, the second field of view may include a diagonal field of view of the second camera 110. For example, the second camera 110 may be positioned on a side of the electronic device 100 on which the first camera 105 is positioned, toward a direction in which the first camera 105 faces. For example, the second camera 110 and the first camera 105 may be disposed on a same side of the electronic device to face in a same direction.

The electronic device 100 exemplified in the description of FIG. 3 may execute at least some of operations exemplified in a description of FIGS. 4 to 14. For example, operations exemplified in the description of FIGS. 4 to 14 may be caused by (or within) the electronic device 100 under control of the at least one processor 300.

FIG. 4 is a flowchart illustrating exemplary operations of an electronic device for obtaining an image compensated for a deteriorated characteristic.

Referring to FIG. 4, in an operation 400, at least one processor 300 may display a preview image on a display 320. For example, the preview image may be obtained based on a first camera 105. For example, the preview image may be displayed to represent an image to be obtained using the first camera 105 in response to an input for obtaining an image.

For example, while displaying the preview image, at least one processor 300 may receive the input. For example, the input may include a user input that executes the first camera 105 to display the preview image on the display 320, and requests shooting while the preview image is displayed. For example, the input may include a touch input for an executable object displayed overlapping (or together with the preview image) the preview image. For example, the input may include a touch input tapping the executable object. For example, the input may include a touch input having a contact point on the executable object. For example, the at least one processor 300 may identify the input through the display 320 (e.g., a touch screen). For example, the input may be provided by an input means (e.g., a button) of an electronic device 100, or may be provided by an input means of an external electronic device (e.g., a stylus pen, a headset, or a smart watch) connected to the electronic device 100.

For example, in an operation 410, the at least one processor 300 may control the first camera 105 to obtain a first image based on the input. For example, the first image may be described as an image obtained using the first camera 105 at a time the input is received. For example, the at least one processor 300 may control a second camera 110 to obtain a second image based on the input. For example, while the first camera 105 is executed (or activated), the second camera 110 may be executed (or activated) based on the input. For example, the second camera 110 may be executed (or activated) to compensate for a deteriorated characteristic of the image obtained from the first camera 105. For example, the second image may be described as an image obtained using the second camera 110 at a time the input is received. For example, the at least one processor 300 may execute (or activate) the second camera 110 to obtain the second image used to compensate for a deteriorated characteristic of the first image.

Referring again to FIG. 1, in the state 115, the user 120 may shoot the subject 135 using the first camera 105 and the second camera 110 of the electronic device 100.

For example, the first image may have the first field of view 125 as the first camera 105 includes the first lens having the first field of view 125. For example, the first image may represent a first scene. For example, the first scene may represent at least a portion of an environment around the electronic device 100 included in the first field of view 125.

For example, the second image may have the second field of view 130 as the second camera 110 includes a second lens having the second field of view 130. For example, the second image may represent a second scene. For example, the second scene may represent at least a part of an environment around the electronic device 100 included in the second field of view 130.

For example, as the first camera 105 and the second camera 110 are positioned on a side of the electronic device 100 to face in substantially the same direction, the first field of view 125 may be partially overlapped with the second field of view 130. For example, as the second field of view 130 is larger than the first field of view 125, and the first field of view 125 is at least partially overlapped with the second field of view 130, the second scene may include the first scene. For example, as the second scene includes the first scene, the second image may include a portion corresponding to the first image.

Referring again to FIG. 4, in an operation 420, the at least one processor 300 may identify a peripheral area of the first image including a periphery of the first image. For example, the peripheral area of the first image may be predetermined according to a first field of view (e.g., the first field of view 125 of FIG. 1) of a first lens. For example, a deteriorated characteristic may be caused in the peripheral area of the first image, including the periphery of the first image.

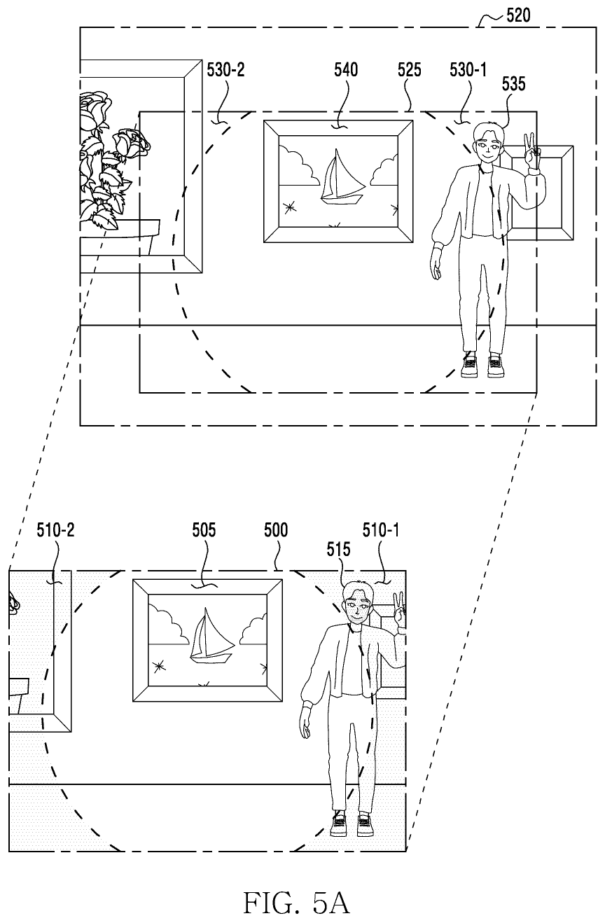

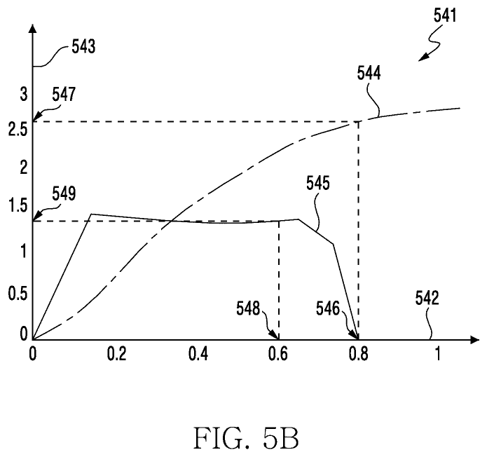

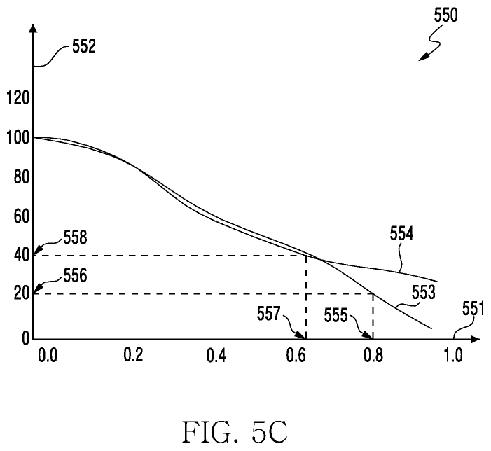

For example, the at least one processor 300 may identify a partial image of the second image corresponding to the peripheral area of the first image, including the periphery of the first image, based on obtaining the second image. Identifying the partial image of the second image will be exemplified in a description of FIG. 5A.

FIG. 5A illustrates an example of a partial image of a second image corresponding to a peripheral area of a first image including a periphery of the first image.

Referring to FIG. 5A, at least one processor 300 may identify a peripheral area 510-1 or 510-2 of a first image 500 including a periphery of the first image 500. For example, in the peripheral area 510-1 or 510-2 of the first image 500 including the periphery of the first image 500, a more deteriorated characteristic may occur than a central area 505 of the first image 500. For example, in FIG. 5A, the peripheral area 510-1 or 510-2 of the first image 500 is illustrated in two areas, but the peripheral area 510-1 or 510-2 of the first image 500 may be one area in which the two areas are connected.

For example, the deteriorated characteristic of the first image 500 may include a deteriorated characteristic by barrel distortion, a deteriorated characteristic related to gradation, and/or a deteriorated characteristic related to relative illumination. For example, the deteriorated characteristic may be caused by refraction of light introduced from the outside through a first lens of a first camera 105. For example, as the refraction of the light increases toward a periphery of the lens, the peripheral area 510-1 or 510-2 of the first image 500, including the periphery of the first image 500, may be more distorted than the central area 505 of the first image 500.

For example, a subject 515 represented in the peripheral area 510-1 or 510-2 of the first image 500, including the periphery of the first image 500, may be stretched or darkened according to the deteriorated characteristic.

For example, a second image 520 may include a portion 525 corresponding to the first image 500. For example, as the second image 520 includes the portion 525 corresponding to the first image 500, the second image 520 may include a partial image 530-1 or 530-2 of the second image 520 corresponding to the peripheral area 510-1 or 510-2 of the first image 500 in the second image 520.

For example, the at least one processor 300 may identify the partial image 530-1 or 530-2 of the second image 520 based on obtaining the second image 520. For example, the partial image 530-1 or 530-2 of the second image 520 may be positioned away from a periphery of the second image 520, in the second image 520. For example, the partial image 530-1 or 530-2 of the second image 520 may be positioned close to a central area of the second image 520 (or within the central area). For example, as the partial image 530-1 or 530-2 of the second image 520 is positioned away from the periphery of the second image 520, the partial image 530-1 or 530-2 of the second image 520 may have a relatively low deteriorated characteristic. For example, the partial image 530-1 or 530-2 of the second image 520 may have a gradation performance higher than that of the peripheral area 510-1 or 510-2 of the first image 500. For example, as the partial image 530-1 or 530-2 of the second image 520 has the higher a gradation performance than that of the peripheral area 510-1 or 510-2 of the first image 500, continuous color or brightness may be expressed in the partial image 530-1 or 530-2 of the second image 520. For example, a subject 535 represented in the partial image 530-1 or 530-2 of the second image 520 may be less stretched or less darkened than the subject 515 represented in the peripheral area 510-1 or 510-2 of the first image 500.

For example, as the first camera 105 has a first field of view (e.g., the first field of view 125 of FIG. 1) narrower than a second field of view (e.g., the second field of view 130 of FIG. 1), the first camera 105 may have an F number smaller than that of a second camera 110 including a second lens. For example, the first camera 105 may have a relatively large amount of light by having a relatively small F number. For example, as the second camera 110 has a relatively large F number, in case that an aperture of the second camera 110 is opened to the maximum, the second image 520 may have a relatively low resolution value due to spherical aberration of the second lens of the second camera 110. For example, as the second camera 110 has a relatively large F number, in case that the aperture of the second camera 110 is opened to the minimum, light diffraction occurs, and the second image 520 may have a relatively low resolution value. For example, as the first camera 105 has an F number smaller than that of the second camera 110, the first image 500 may have a resolution value higher than that of the second image 520.

For example, the first camera 105 may have an optical format larger than that of the second camera 110. For example, as the first camera 105 has the optical format larger than that of the second camera 110, and the first camera 105 has the first field of view narrower than the second field of view, the first image 500 may have a resolution value higher than that of the second image 520.

For example, the second image 520 may include a partial area 540 corresponding to the central area 505 of the first image 500. For example, as the first image 500 has a resolution value higher than that of the second image 520, the central area 505 of the first image 500 may have a resolution value higher than that of the partial area 540 of the second image 520. For example, as the central area 505 of the first image 500 includes a relatively low deteriorated characteristic, it may not be required in the electronic device 100 to compensate for a deteriorated characteristic caused in the central area 505 of the first image 500.

For example, the at least one processor 300 may use the partial image 530-1 or 530-2 of the second image 520 to compensate for a deteriorated characteristic caused in the peripheral area 510-1 or 510-2 of the first image 500.

FIG. 5B illustrates a chart representing a change in a distortion amount according to an area of a lens.

Referring to FIG. 5B, a chart 541 represents a change in a distortion amount according to an area of a lens. A horizontal axis 542 in the chart 541 represents an area of a lens, and a vertical axis 543 in the chart 541 represents a degree of distortion of an image.

For example, a distortion amount of the first image 500 obtained through the first camera 105 may be expressed as a line 544 in the chart 541. For example, a distortion amount of the second image 520 obtained through the second camera 110 may be expressed as a line 545 in the chart 541.

For example, according to the line 544 in the chart 541, the first image 500 may have a greater degree of distortion in a peripheral area than a central area. For example, the first image 500 may have a first distortion amount 547 in a first area 546 within the first image 500. For example, the second image 520 may have a second distortion amount 549 in a second area 548 within the second image 520. For example, the first distortion amount 547 may be relatively greater than the second distortion amount 549. As a non-limiting example, a distortion amount of the peripheral area of the first image 500 may be 1.3 times or more of the distortion amount of the second image 520. As a non-limiting example, the distortion amount of the peripheral area of the first image 500 may be 2.7 times or less of the distortion amount of the second image 520. However, it is not limited thereto.

For example, a scene represented by the first area 546 in the first image 500 may substantially correspond to a scene represented by the second area 548 in the second image 520. For example, the at least one processor 300 may compensate for distortion by using an area including the second area 548 in the second image 520, with respect to a peripheral area including the first area 546 in the first image 500.

FIG. 5C illustrates a chart representing a change in relative illumination according to an area of a lens.

Referring to FIG. 5C, a chart 550 represents a change in relative illumination according to an area of a lens. A horizontal axis 551 in the chart 550 represents an area of a lens, and a vertical axis 552 in the chart 550 represents relative illumination. For example, the relative illumination may be defined as illumination incident on a center portion and a periphery portion of a camera. For example, as a back focal length of the lens decreases, the relative illumination may decrease. For example, a light source may be incident on the lens by being inclined at a certain angle. For example, the light source may not converge to a photodiode of the camera by being incident at a certain angle with respect to the lens. For example, as the light source does not converge to the photodiode of the camera, a decrease in the relative illumination may occur.

As a non-limiting example, the relative illumination of the second image 520 may be 1.7 times or more of relative illumination of the peripheral area of the first image 500. As a non-limiting example, the relative illumination of the second image 520 may be less than 3 times the relative illumination of the peripheral area of the first image 500. However, it is not limited thereto.

For example, relative illumination of the first image 500 obtained through the first camera 105 may be expressed as a line 553 in the chart 550. For example, the relative illumination of the second image 520 obtained through the second camera 110 may be expressed as a line 554 in the chart 550.

For example, according to the line 553 in the chart 550, the first image 500 may have lower relative illumination in a peripheral area than a central area. For example, the first image 500 may have first relative illumination 556 in a first area 555 within the first image 500. For example, the second image 520 may have second relative illumination 558 in a second area 557 within the second image 520. For example, the first relative illumination 556 may be relatively lower than the second relative illumination 558.

For example, a scene represented by the first area 555 in the first image 500 may substantially correspond to a scene represented by the second area 557 in the second image 520. For example, the at least one processor 300 may compensate for a deteriorated characteristic of the first image 500 by relative illumination using an area including the second area 557 in the second image 520, with respect to a peripheral area including the first area 555 in the first image 500.

Referring again to FIG. 4, in the operation 430, the at least one processor 300 may execute a model using the first image 500 and the partial image 530-1 or 530-2 of the second image 520. For example, the at least one processor 300 may execute the model by providing the model with the first image 500 and the partial image 530-1 or 530-2 of the second image 520. For example, the at least one processor 300 may obtain a third image based on execution of the model.

For example, in the operation 440, the at least one processor 300 may store the third image in memory 310 as a result of the input (e.g., the input in the operation 400 of FIG. 4).

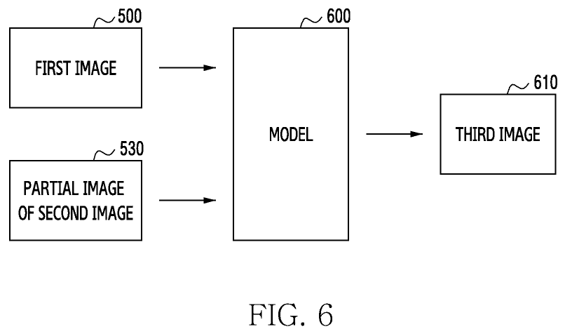

An operation of executing the model to obtain the third image will be exemplified in a description of FIG. 6.

FIG. 6 illustrates an example of executing a model to obtain an image compensated for a deteriorated characteristic.

Referring to FIG. 6, an electronic device 100 may include a model 600. For example, the model 600 may include a machine learning model, a deep learning model, and/or a generative artificial intelligence model. For example, the model 600 may be trained to compensate for a deteriorated characteristic (e.g., the deteriorated characteristic of the first image 500 in the description of FIG. 5A) of a first image 500 caused in a peripheral area 510-1 or 510-2 of the first image 500 by a first camera 105.

For example, at least one processor 300 may execute the model 600 using the first image 500 and a partial image 530 (e.g., the partial image 530-1 or 530-2 of the second image 520 of FIG. 5A) of a second image. For example, the at least one processor 300 may execute the model 600 by providing the first image 500 and the partial image 530 of the second image to the model 600.

For example, the at least one processor 300 may obtain a third image 610 based on execution of the model 600. For example, the at least one processor 300 may store the third image 610 in the memory 310 as a result of the input (e.g., the input in the operation 400 of FIG. 4).

As a non-limiting example, a server may include the model 600. The at least one processor 300 may transmit the first image 500 and the partial image 530 of the second image to the server. The server may receive the first image 500 and the partial image 530 of the second image from the electronic device 100. The server may execute the model 600 by using the received first image 500 and the received partial image 530 of the second image. The server may obtain the third image 610 based on the execution of the model 600. The server may transmit the third image 610 to the electronic device 100. The at least one processor 300 may receive the third image 610 from the server. The at least one processor 300 may obtain the third image 610 by receiving the third image 610 from the server. However, it is not limited thereto.

As a non-limiting example, the at least one processor 300 may input (or provide) the first image 500 and the second image (e.g., the second image 520 of FIG. 5A) to the model 600. For example, the at least one processor 300 may execute the model 600 by inputting (or providing) the first image 500 and the second image 520 to the model 600.

For example, the model 600 may identify a portion (e.g., the portion 525 of FIG. 5A) corresponding to the first image 500 in the second image 520. For example, the model 600 may obtain the third image 610 by compensating for a deteriorated characteristic of the first image 500 based on identifying a portion corresponding to the first image 500 in the second image 520. For example, the at least one processor 300 may obtain the third image 610 based on the execution of the model 600. However, it is not limited thereto.

According to an embodiment of the disclosure, the model 600 may be a neural network model including a plurality of layers and/or operations (or calculations). According to an embodiment of the disclosure, the model 600 may be one of a feedforward neural network (FNN), a deep neural network (DNN), a convolutional neural network (CNN), a region with convolution neural network (R-CNN), a region proposal network (RPN), a recurrent neural network (RNN), a stacking-based deep neural network (S-DNN), a state-space dynamic neural network (S-SDNN), deconvolution Network, a restricted Boltzmann machine (RBM), a deep belief network (DBN), a bidirectional recurrent deep neural network (BRDNN), deep Q-networks, a fully convolutional network, long short-term memory (LSTM) network, a classification network, or a combination of two or more of the above, but it is not limited to the above-described examples. According to an embodiment of the disclosure, the model 600 may be trained on designated data, obtain input data, and perform a calculation based on the input data to generate output data. The model 600 may additionally or alternatively include a software structure, in addition to hardware structure.

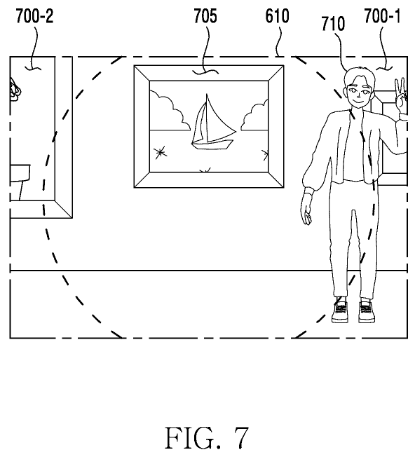

For example, the third image 610 may include a partial image compensated for a deteriorated characteristic caused in the peripheral area 510-1 or 510-2 of the first image 500. The third image 610 will be exemplified in a description of FIG. 7.

FIG. 7 illustrates an example of an image in which a deteriorated characteristic is compensated.

Referring to FIG. 7, a third image 610 may include a peripheral area 700-1 or 700-2 of the third image 610 corresponding to a peripheral area (e.g., the peripheral area 510-1 or 510-2 of FIG. 5A) of a first image 500. For example, in FIG. 7, the peripheral area 700-1 or 700-2 of the third image 610 is illustrated as two areas, but the peripheral area 700-1 or 700-2 of the third image 610 may be one area in which the two areas are connected. For example, the peripheral area 700-1 or 700-2 of the third image 610 may be described as an area compensated for a deteriorated characteristic caused by the peripheral area 510-1 or 510-2 of the first image 500. For example, the peripheral area 700-1 or 700-2 of the third image 610 may be determined using a partial image (e.g., the partial image 530 of the second image of FIG. 6) of a second image having a deteriorated characteristic less than the deteriorated characteristic caused in the peripheral area 510-1 or 510-2 of the first image 500.

For example, the third image 610 may include a central area 705 of the third image 610 corresponding to a central area (e.g., the central area 505 of FIG. 5A) of the first image 500. For example, the central area 705 of the third image 610 may be determined using the central area 505 of the first image 500 having a resolution value higher than that of a partial area (e.g., the partial area 540 of FIG. 5A) of a second image 520.

As a non-limiting example, the third image 610 may be described as an image in which the first image 500 and a partial image 530 of the second image are synthesized. As a non-limiting example, at least one processor 300 may obtain the third image 610 by synthesizing the first image 500 and the partial image 530 of the second image so that a boundary between the first image 500 and the partial image 530 of the second image is connected, based on execution of a model (e.g., the model 600 of FIG. 6). However, it is not limited thereto.

For example, as the third image 610 is obtained based on the partial image 530 of the second image, the peripheral area 700-1 or 700-2 of the third image 610 may have a deteriorated characteristic less than that of the peripheral area 510-1 or 510-2 of the first image 500. For example, as the peripheral area 700-1 or 700-2 of the third image 610 has a deteriorated characteristic less than that of the peripheral area 510-1 or 510-2 of the first image 500, a subject 710 in the peripheral area 700-1 or 700-2 of the third image 610 may be expressed less stretched or less darkened than a subject (e.g., the subject 515 of FIG. 5A) in the peripheral area 510-1 or 510-2 of the first image 500.

For example, as the central area 705 of the third image 610 is obtained based on the central area 505 of the first image 500, the central area 705 of the third image 610 may have a resolution value higher than that of the partial area (e.g., the partial area 540 of the second image 520 of FIG. 5A) of the second image.

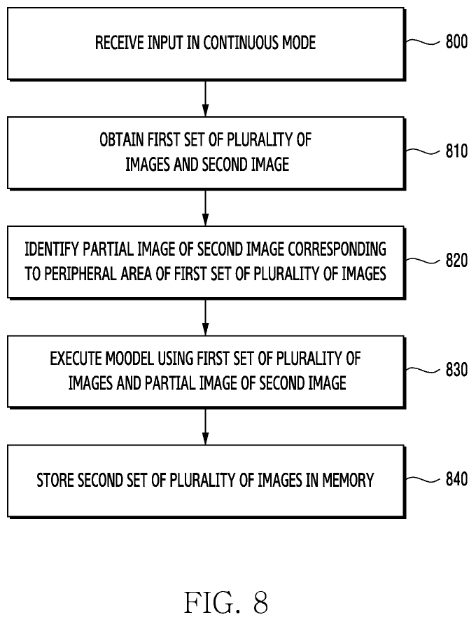

For example, the at least one processor 300 may obtain a first set of a plurality of images using a first camera 105 in a continuous mode. For example, the first set of the plurality of images may include a deteriorated characteristic caused in a peripheral area of each of the first set of the plurality of images. For example, an operation to compensate for the deteriorated characteristic may be exemplified in a description of FIG. 8.

FIG. 8 is a flowchart illustrating exemplary operations of an electronic device for obtaining a set of a plurality of images compensated for a deteriorated characteristic.

Referring to FIG. 8, in an operation 800, at least one processor 300 may display a preview image in a continuous mode. For example, the at least one processor 300 may receive an input for obtaining an image using a first camera 105 while the preview image is displayed in the continuous mode. For example, the input may refer to the input in the operation 400 of FIG. 4.

For example, in an operation 810, the at least one processor 300 may control the first camera 105 to obtain the first set of the plurality of images based on the input received in the continuous mode. For example, the first set of the plurality of images may include a first image (e.g., the first image 500 of FIG. 5A). For example, the first set of the plurality of images may include continuously shot images. For example, the first set of the plurality of images may include images obtained using the first camera 105 until a reference time elapses from a time point when the input is received.

For example, the at least one processor 300 may control a second camera 110 to obtain a second image (e.g., the second image 520 of FIG. 5A) based on the input received in the continuous mode.

For example, as the first camera 105 has a first field of view (e.g., the first field of view 125 of FIG. 1), the first set of the plurality of images may have the first field of view 125. For example, as the second camera 110 has a second field of view (e.g., the second field of view 130 of FIG. 1), the second image 520 may have the second field of view 130.

For example, as the second field of view 130 is larger than the first field of view 125, and the first field of view 125 overlaps at least partially with the second field of view 130, the second image 520 may include a portion corresponding to the first set of the plurality of images.

For example, in an operation 820, the at least one processor 300 may identify a peripheral area of the first set of the plurality of images including a periphery of the first set of the plurality of images. For example, the peripheral area of the first set of the plurality of images may correspond to a peripheral area (e.g., the peripheral area 510-1 or 510-2 of the first image 500 of FIG. 5A) of the first image 500. For example, a deteriorated characteristic may be caused in the peripheral area of the first set of the plurality of images including the periphery of the first set of the plurality of images.

For example, the at least one processor 300 may identify a partial image (e.g., the partial image 530-1 or 530-2 of FIG. 5A) of the second image 520 corresponding to the peripheral area of the first set of the plurality of images including the periphery of the first set of the plurality of images based on obtaining the second image 520.

For example, in an operation 830, the at least one processor 300 may execute a model (e.g., the model 600 of FIG. 6) using the first set of the plurality of images and the partial image 530-1 or 530-2 of the second image 520. For example, the at least one processor 300 may execute the model 600 by providing the model 600 with the first set of the plurality of images and the partial image 530-1 or 530-2 of the second image 520. For example, the at least one processor 300 may obtain a second set of the plurality of images based on execution of the model 600.

For example, in an operation 840, the at least one processor 300 may store the second set of the plurality of images in the memory 310 as a result of an input (e.g., the input in the operation 800 of FIG. 8). For example, the second set of the plurality of images may be stored in association with a third image (e.g., the third image 610 of FIG. 6). For example, the at least one processor 300 may store a file including the second set of the plurality of images in the memory 310.

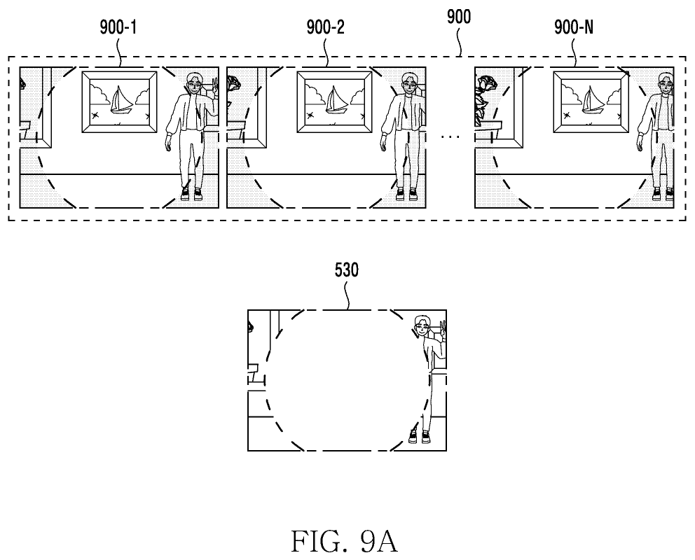

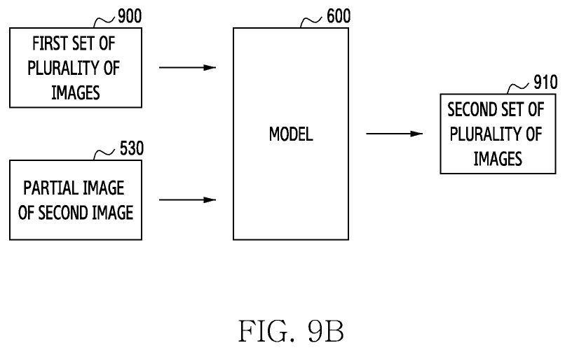

The first set of the plurality of images and the partial image 530 of the second image 520 used to execute a model will be exemplified in a description of FIG. 9A.

FIG. 9A illustrates an example of a set of a plurality of images obtained using a first camera and a partial image of an image obtained using a second camera.

Referring to FIG. 9A, a first set 900 of a plurality of images may include a first image 900-1. For example, the first image 900-1 may correspond to the first image 500 of FIG. 5A. For example, the first image 900-1 may be described as an image obtained using a first camera 105 at a time point when an input is received in a continuous mode.

For example, the first set 900 of the plurality of images may include a plurality of images 900-1, 900-2, and 900-N obtained continuously. For example, the first set 900 of the plurality of images may include a plurality of images obtained from a time point when an input is received until a reference time elapses in a continuous mode. For example, the first set 900 of the plurality of images 900-1, 900-2, and 900-N may be at least partially different from each other. For example, as the first set 900 of the plurality of images 900-1, 900-2, and 900-N are continuously obtained, each of the first set 900 of the plurality of images 900-1, 900-2, and 900-N may have a relatively small difference.

For example, a partial image 530 of a second image (e.g., the second image 520 of FIG. 5A) may correspond to a peripheral area of the first set 900 of the plurality of images 900-1, 900-2, and 900-N. For example, a first time point of a scene represented by the partial image 530 of the second image 520 may correspond to a first time point of a scene represented by a peripheral area of the first image 900-1. For example, among the first set 900 of the plurality of images 900-1, 900-2, and 900-N, the images 900-2 and 900-N excluding the first image 900-1 may represent scenes of second time points after the first time point. For example, as each of the first set 900 of the plurality of images 900-1, 900-2, and 900-N has a relatively small difference, the difference between the scene of the first time point and the scenes of the second time points may be described as not relatively large.

For example, as the difference between the scene of the first time point and the scenes of the second time points is relatively small, obtaining a second set of a plurality of images using the first set 900 of the plurality of images and the partial image 530 of the second image 520 may not have an error. A model (e.g., the model 600 of FIG. 6) being executed to obtain the second set of the plurality of images will be exemplified in the description of FIG. 9B.

FIG. 9B illustrates an example of executing a model to obtain a set of a plurality of images compensated for a deteriorated characteristic.

Referring to FIG. 9B, at least one processor 300 may execute the model 600 using the first set 900 of the plurality of images and the partial image 530 of the second image 520. For example, the model 600 may be described by the model 600 of FIG. 6. For example, the at least one processor 300 may execute the model 600 by providing the model 600 with the first set 900 of the plurality of images and the partial image 530 of the second image 520.

For example, the at least one processor 300 may obtain a second set 910 of the plurality of images based on execution of the model 600. For example, the at least one processor 300 may store the second set 910 of the plurality of images in the memory 310 as a result of the input (e.g., the input in the operation 800 of FIG. 8).

For example, the second set 910 of the plurality of images may include partial images in which a deteriorated characteristic caused by the peripheral areas of each of the first set 900 of the plurality of images 900-1, 900-2, and 900-N is compensated.

For example, each of the second set 910 of the plurality of images may refer to the description of FIG. 7. For example, each of the second set 910 of the plurality of images may be described as images in which each of the first set 900 of the plurality of images 900-1, 900-2, and 900-N and the partial image 530 of the second image are synthesized.

For example, the peripheral area of the second set 910 of the plurality of images may have a deteriorated characteristic less than that of the peripheral area of the first set 900 of the plurality of images 900-1, 900-2, and 900-N by being obtained based on the partial image 530 of the second image. For example, as the peripheral area of the second set 910 of the plurality of images has a deteriorated characteristic less than that of the peripheral area of the first set 900 of the plurality of images 900-1, 900-2, and 900-N, a subject in the peripheral area of the second set 910 of the plurality of images may be expressed less stretched or less darkened than a subject in the peripheral area of the first set 900 of the plurality of images 900-1, 900-2, and 900-N. For example, the second set 910 of the plurality of images may have a resolution value higher than that of the partial area (e.g., the partial area 540 of FIG. 5A) of the second image 520 by being obtained based on the first set 900 of the plurality of images 900-1, 900-2, and 900-N.

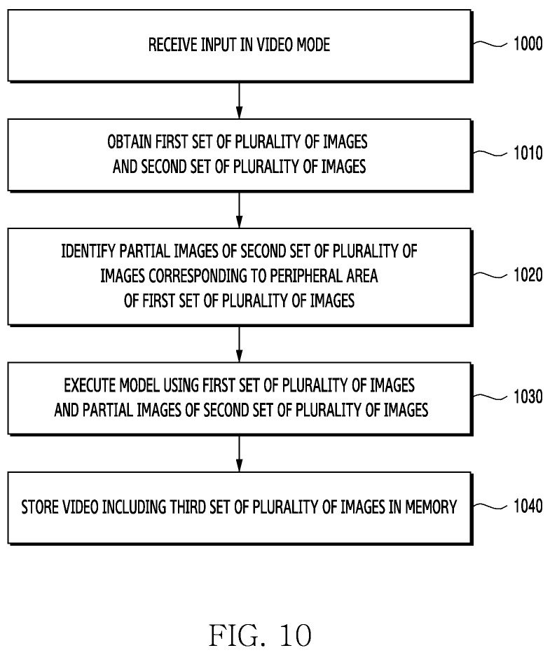

For example, the at least one processor 300 may obtain a first set of the plurality of images using the first camera 105 in a video mode. For example, the first set of the plurality of images may include a deteriorated characteristic caused in a peripheral area of each of the first set of the plurality of images. For example, an operation to compensate for the deteriorated characteristic may be exemplified in a description of FIG. 10.

FIG. 10 is a flowchart illustrating exemplary operations of an electronic device to obtain a video including an image compensated for a deteriorated characteristic.

Referring to FIG. 10, in an operation 1000, at least one processor 300 may display a preview image in a video mode. For example, the at least one processor 300 may receive an input while the preview image is displayed in the video mode. For example, the input may refer to the input in the operation 400 of FIG. 4.

For example, in an operation 1010, the at least one processor 300 may control a first camera 105 to obtain a first set of a plurality of images based on the input received in the video mode. For example, the first set of the plurality of images may include a first image (e.g., the first image 500 of FIG. 5A). For example, the first set of the plurality of images may include continuously shot images. For example, the first set of the plurality of images may include images obtained using the first camera 105 from a time point when an input is received to a time point when an input to cease shooting is received.

For example, the at least one processor 300 may control a second camera 110 to obtain a second set of a plurality of images based on the input received in the video mode. For example, the second set of the plurality of images may include a second image (e.g., the second image 520 of FIG. 5A). For example, the second set of the plurality of images may include continuously shot images. For example, the second set of the plurality of images may include images obtained using the second camera 110 from a time point when an input is received to a time point when an input to cease shooting is received.

For example, as the first camera 105 has a first field of view (e.g., the first field of view 125 of FIG. 1), the first set of the plurality of images may have the first field of view 125. For example, as the second camera 110 has a second field of view (e.g., the second field of view 130 of FIG. 1), the second set of the plurality of images may have the second field of view 130.

For example, as the second field of view 130 is wider than the first field of view 125, and the first field of view 125 overlaps at least partially with the second field of view 130, the second set of the plurality of images may include a portion corresponding to the first set of the plurality of images.

For example, in an operation 1020, the at least one processor 300 may identify a peripheral area of the first set of the plurality of images including a periphery of the first set of the plurality of images. For example, the peripheral area of the first set of the plurality of images may correspond to a peripheral area of a first image 500 (e.g., the peripheral area 510-1 or 510-2 of the first image 500 of FIG. 5A). For example, the at least one processor 300 may cause a deteriorated characteristic in the peripheral area of the first set of the plurality of images including the periphery of the first set of the plurality of images.

For example, the at least one processor 300 may identify partial images of the second set of the plurality of images corresponding to the peripheral area of the first set of the plurality of images including the periphery of the first set of the plurality of images based on obtaining the second set of the plurality of images.

For example, in an operation 1030, the at least one processor 300 may execute a model (e.g., the model 600 of FIG. 6) using the first set of the plurality of images and the partial images of the second set of the plurality of images. For example, the at least one processor 300 may execute the model 600 by providing the model 600 with the first set of the plurality of images and the partial images of the second set of the plurality of images. For example, the at least one processor 300 may obtain a video including a third set of a plurality of images based on execution of the model.

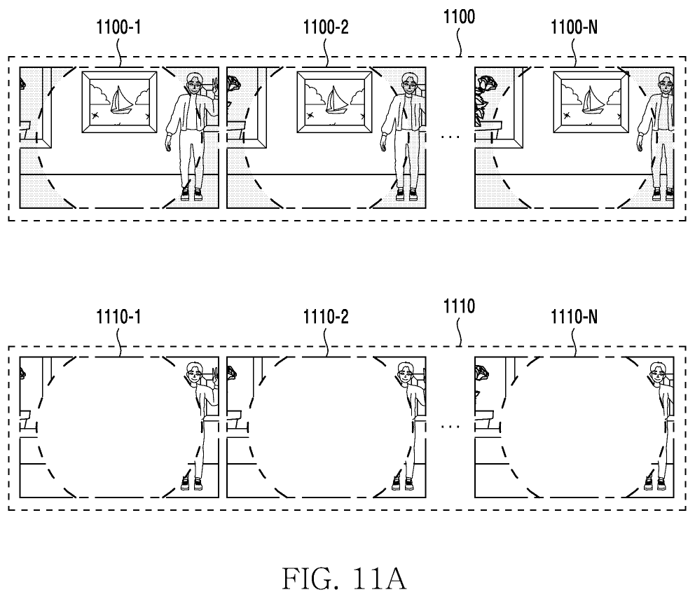

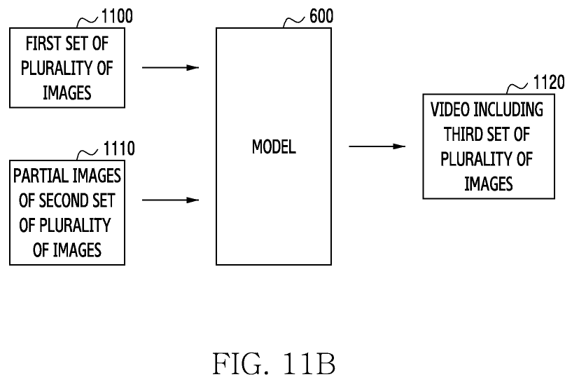

For example, in an operation 1040, the at least one processor 300 may store a video including the third set of the plurality of images in the memory 310 as a result of an input (e.g., the input in the operation 1000 of FIG. 10). The first set of the plurality of images and of the partial images of the second set of the plurality of images used to execute the model will be exemplified in a description of FIG. 11A.

FIG. 11A illustrates an example of a set of a plurality of images obtained using a first camera, and partial images of a set of a plurality of images obtained using a second camera.

Referring to FIG. 11A, a first set 1100 of a plurality of images may include a first image 1100-1. For example, the first image 1100-1 may correspond to the first image 500 of FIG. 5A. For example, the first image 1100-1 may be described as an image obtained using a first camera 105 at a time point when an input is received in a video mode.

For example, the first set 1100 of the plurality of images may include a plurality of images 1100-1, 1100-2, and 1100-N continuously obtained using the first camera 105. For example, the first set 1100 of the plurality of images may include the plurality of images obtained from a time point when an input is received to a time point when an input to cease shooting is received in the video mode.

For example, partial images 1110 of a second set of a plurality of images may include a partial image 1110-1 of a second image. For example, the partial image 1110-1 of the second image may correspond to the partial image 530-1 or 530-2 of the second image 520 of FIG. 5A. For example, each of the partial images 1110 of the second set of the plurality of images may correspond to a peripheral area of each of the first set 1100 of the plurality of images 1100-1, 1100-2, and 1100-N.

For example, the peripheral area of each of the first set 1100 of the plurality of images 1100-1, 1100-2, and 1100-N may correspond to each of the partial images 1110 of the second set of the plurality of images. For example, a scene represented by the peripheral area of the first image 1100-1 may correspond to a scene represented by the partial image 1110-1 of the second image. For example, the peripheral area of an image 1100-N among the first set 1100 of the plurality of images 1100-1, 1100-2, and 1100-N may correspond to an image 1110-N among the partial images 1110 of the second set of the plurality of images. A model (e.g., the model 600 of FIG. 6) being executed to obtain a video including a third set of a plurality of images will be exemplified in a description of FIG. 11B.

FIG. 11B illustrates an example of executing a model to obtain a video including an image compensated for a deteriorated characteristic.

Referring to FIG. 11B, at least one processor 300 may execute the model 600 using the first set 1100 of the plurality of images and the partial images 1110 of the second set of the plurality of images. For example, the model 600 may be described by the model 600 of FIG. 6. For example, the at least one processor 300 may execute the model 600 by providing the model 600 with the first set 1100 of the plurality of images and the partial images 1110 of the second set of the plurality of images.

For example, the at least one processor 300 may obtain a video 1120 including the third set of the plurality of images based on execution of the model 600. For example, the at least one processor 300 may store the video 1120 including the third set of the plurality of images in the memory 310 as a result of the input (e.g., the input in the operation 1000 of FIG. 10).

For example, the third set of the plurality of images may include partial images compensated for a deteriorated characteristic caused in the peripheral area of each of the first set 1100 of the plurality of images 1100-1, 1100-2, and 1100-N.

For example, each of the third set of the plurality of images may refer to the description of FIG. 7. For example, each of the third set of the plurality of images may be described as images in which each of the first set 1100 of the plurality of images 1100-1, 1100-2, and 1100-N and each of the partial images 1110 of the second set of the plurality of images 1110-1, 1110-2, and 1110-N are synthesized.

For example, peripheral areas of the third set of the plurality of images may have a deteriorated characteristic less than that of the peripheral area of the first set 1100 of the plurality of images 1100-1, 1100-2, and 1100-N by being obtained based on the partial images 1110 of the second set of the plurality of images. For example, as the peripheral area of the third set of the plurality of images has a deteriorated characteristic less than that of the peripheral area of the first set 1100 of the plurality of images 1100-1, 1100-2, and 1100-N, a subject in the peripheral area of the third set of the plurality of images may be expressed less stretched or less darkened than a subject in the peripheral area of the first set 1100 of the plurality of images 1100-1, 1100-2, and 1100-N.

For example, a central area of the third set of the plurality of images may have a resolution value higher than that of the partial area (e.g., the partial area of the second set of the plurality of images corresponding to the partial area 540 of FIG. 5A) of the second set of the plurality of images, by being obtained based on a central area of the first set 1100 of the plurality of images 1100-1, 1100-2, and 1100-N.

For example, as the video 1120 includes the third set of the plurality of images, a peripheral area of frames of the video 1120 may have a deteriorated characteristic less than that of a peripheral area of frames of a video including the first set 1100 of the plurality of images. For example, since the video 1120 includes the third set of the plurality of images, the video 1120 may have a resolution value higher than that of a video including the second set of the plurality of images.

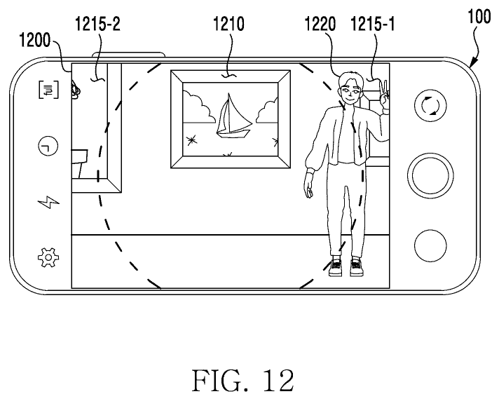

FIG. 12 illustrates an example of displaying a preview image compensated for a deteriorated characteristic.

Referring to FIG. 12, at least one processor 300 may compensate for a deteriorated characteristic of a preview image displayed before receiving an input (e.g., the input in the operation 400 of FIG. 4, the input in the operation 800 of FIG. 8, and/or the input in the operation 1000 of FIG. 10). For example, the at least one processor 300 may control a first camera 105 to obtain a fourth image based on executing a software application (hereinafter, a camera software application) that provides a function for a camera. For example, as the first camera 105 has a first field of view (e.g., the first field of view 125 of FIG. 1), the fourth image may have the first field of view 125. For example, the fourth image may correspond to the first image 500 of FIG. 5A. For example, the fourth image may have a second resolution lower than a first resolution of the first image 500.

For example, the at least one processor 300 may control a second camera 110 to obtain a fifth image based on executing the camera software application. For example, as the second camera 110 has a second field of view (e.g., the second field of view 130 of FIG. 1), the fifth image may have the second field of view 130. For example, the fifth image may correspond to the second image 520 of FIG. 5A. For example, the fifth image may have a fourth resolution lower than a third resolution of the second image 520.

For example, the at least one processor 300 may identify a peripheral area of the fourth image including a periphery of the fourth image. For example, the peripheral area of the fourth image may correspond to the peripheral area 510-1 or 510-2 of the first image 500 of FIG. 5A. For example, the peripheral area of the fourth image may be predetermined according to the first field of view of the first camera 105. For example, a deteriorated characteristic may be caused in the peripheral area of the fourth image, including the periphery of the fourth image.

For example, the at least one processor 300 may identify a partial image of the fifth image corresponding to the peripheral area of the fourth image, including the periphery of the fourth image, based on obtaining the fifth image. For example, the partial image of the fifth image may correspond to the partial image 530-1 or 530-2 of the second image 520 of FIG. 5A. For example, an operation of identifying the partial image of the fifth image corresponding to the peripheral area of the fourth image, including the periphery of the fourth image, may refer to the description of FIG. 5A.

For example, the at least one processor 300 may execute a model using the fourth image and the partial image of the fifth image. For example, the at least one processor 300 may execute the model by providing the model with the fourth image and the partial image of the fifth image. For example, the at least one processor 300 may obtain a sixth image 1200 based on execution of the model. For example, the sixth image 1200 may correspond to the third image 610 of FIG. 7. For example, the sixth image 1200 may have a sixth resolution lower than a fifth resolution of the third image 610. For example, an operation of obtaining the sixth image 1200 may refer to the description of FIG. 6.

For example, the sixth image 1200 may include a central area 1210 of the sixth image 1200 corresponding to a central area of the fourth image. For example, the central area 1210 of the sixth image 1200 may be determined using the central area of the fourth image having a resolution value higher than a resolution value of the partial area (e.g., the partial area 540 of FIG. 5A) of the fifth image.

As a non-limiting example, the sixth image 1200 may be described as an image in which the fourth image and the partial image of the fifth image are synthesized. As a non-limiting example, the at least one processor 300 may obtain the sixth image 1200 by synthesizing the fourth image and the partial image of the fifth image so that a boundary between the fourth image and the partial image of the fifth image is connected based on execution of the model (e.g., the model 600 of FIG. 6). However, it is not limited thereto.

For example, a peripheral area 1215-1 or 1215-2 of the sixth image 1200 may have a deteriorated characteristic less than that of the peripheral area of the fourth image by obtaining based on the partial image of the fifth image. For example, as the peripheral area 1215-1 or 1215-2 of the sixth image 1200 has a deteriorated characteristic less than that of the peripheral area of the fourth image, a subject 1220 in the peripheral area 1215-1 or 1215-2 of the sixth image 1200 may be expressed less stretched or less darkened than a subject (e.g., the subject 515 of FIG. 5A) in the peripheral area of the fourth image.

For example, the central area 1210 of the sixth image 1200 may have a resolution value higher than that of the partial area (e.g., the partial area 540 of FIG. 5A) of the fifth image by being obtained based on the central area of the fourth image.

For example, the at least one processor 300 may display the sixth image 1200 through a display 320 based on obtaining the sixth image 1200. For example, the at least one processor 300 may provide an image having a deteriorated characteristic less than that of the peripheral area of the fourth image by replacing the fourth image to display the sixth image.

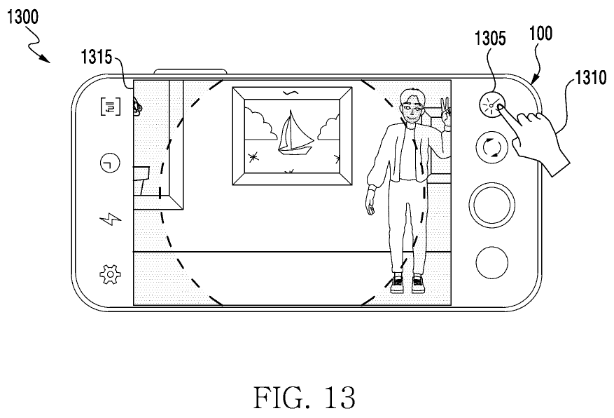

For example, the camera software application may include a plurality of modes. For example, the camera software application may include a normal mode, a continuous mode, and/or a video mode. For example, the camera software application may further include a mode for obtaining the third image (e.g., the third image 610 of FIG. 6) based on an input. For example, a user input for switching from the normal mode (or the continuous mode or the video mode) to a mode for obtaining the third image 610 will be exemplified in a description of FIG. 13.

FIG. 13 illustrates an example of a user input for switching a mode.

Referring to FIG. 13, a state 1300 may be described as a state in which an electronic device 100 is in a normal mode (or a continuous mode or a video mode). For example, in the state 1300, at least one processor 300 may display a preview image 1315 through a display 320. For example, the at least one processor 300 may display an executable object 1305 for switching a mode by overlapping (or next to the area where the preview image is displayed) the preview image 1315.

For example, the at least one processor 300 may receive an input 1310 for the executable object 1305. For example, the input 1310 for the executable object 1305 may include a touch input tapping the executable object 1305. For example, the input 1310 for the executable object 1305 may include a touch input having a contact point on the executable object 1305. For example, the at least one processor 300 may identify the touch input for the executable object 1305 through the display 320 (e.g., a touch screen).

For example, the at least one processor 300 may switch from the normal mode (or the continuous mode, or the video mode) to a mode for obtaining a third image (e.g., the third image 610 of FIG. 6) based on the input 1310 for the executable object 1305. For example, the at least one processor 300 may perform the operations 400 to 440 of FIG. 4 in the mode for obtaining the third image 610.

FIG. 14 illustrates an example of obtaining an image with improved image quality.

Referring to FIG. 14, an electronic device 100 may further include a third camera. For example, the third camera may have a third field of view. For example, the third field of view may be narrower than a first field of view (e.g., the first field of view 125 of FIG. 1). For example, the third camera may be positioned on a side of the electronic device 100 on which the first camera 105 is positioned, toward a direction in which a first camera 105 faces. For example, the third camera may include a telephoto lens. For example, the third camera may be described as the telephoto camera.

For example, at least one processor 300 may obtain a fourth image 1400 using the third camera. For example, as the third camera includes the telephoto lens, the fourth image 1400 may have a resolution value higher than that of a first image (e.g., the first image 500 of FIG. 5A). For example, as the third camera has the third field of view narrower than the first field of view 125, a scene represented by the fourth image 1400 may be included in a scene represented by the first image (e.g., the first image 500 of FIG. 5A). For example, the first image 500 may include an area 1405 corresponding to the fourth image 1400. For example, the at least one processor 300 may improve image quality of the area 1405 in the first image 500 by using the fourth image 1400. For example, the at least one processor 300 may use the fourth image 1400 to improve image quality of the third image 610 compensated for a deteriorated characteristic of the first image 500 of FIG. 7.

For example, the at least one processor 300 may provide (or input) the first image 500 (or the third image 610) and the fourth image 1400 to a model trained to improve image quality of an image. For example, the model may correspond to the model 600 of FIG. 6. For example, the model may include a machine learning model, a deep learning model, and/or a generative artificial intelligence model.

For example, the at least one processor 300 may execute the model by providing (or inputting) the first image 500 (or the third image 610) and the fourth image 1400 to the model. For example, the at least one processor 300 may obtain a fifth image with the improved image quality of the area 1405 in the first image 500 (or the third image 610) based on execution of the model.

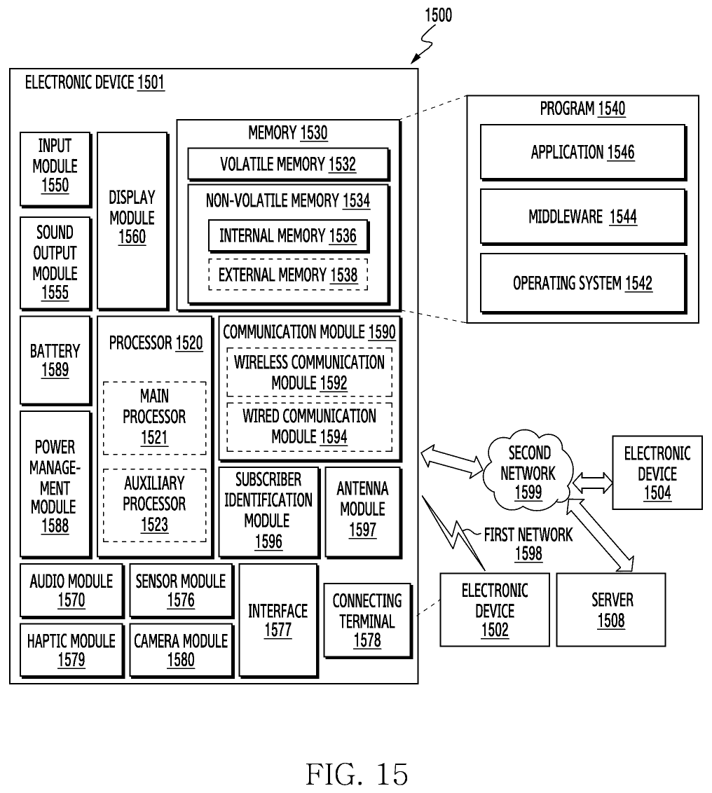

FIG. 15 is a block diagram illustrating an electronic device 1501 in a network environment 1500 according to various embodiments.

Referring to FIG. 15, the electronic device 1501 in the network environment 1500 may communicate with an electronic device 1502 via a first network 1598 (e.g., a short-range wireless communication network), or at least one of an electronic device 1504 or a server 1508 via a second network 1599 (e.g., a long-range wireless communication network). According to an embodiment, the electronic device 1501 may communicate with the electronic device 1504 via the server 1508. According to an embodiment, the electronic device 1501 may include a processor 1520, memory 1530, an input module 1550, a sound output module 1555, a display module 1560, an audio module 1570, a sensor module 1576, an interface 1577, a connecting terminal 1578, a haptic module 1579, a camera module 1580, a power management module 1588, a battery 1589, a communication module 1590, a subscriber identification module (SIM) 1596, or an antenna module 1597. In some embodiments, at least one of the components (e.g., the connecting terminal 1578) may be omitted from the electronic device 1501, or one or more other components may be added in the electronic device 1501. In some embodiments, some of the components (e.g., the sensor module 1576, the camera module 1580, or the antenna module 1597) may be implemented as a single component (e.g., the display module 1560).

The processor 1520 may execute, for example, software (e.g., a program 1540) to control at least one other component (e.g., a hardware or software component) of the electronic device 1501 coupled with the processor 1520, and may perform various data processing or computation. According to an embodiment, as at least part of the data processing or computation, the processor 1520 may store a command or data received from another component (e.g., the sensor module 1576 or the communication module 1590) in volatile memory 1532, process the command or the data stored in the volatile memory 1532, and store resulting data in non-volatile memory 1534. According to an embodiment, the processor 1520 may include a main processor 1521 (e.g., a central processing unit (CPU) or an application processor (AP)), or an auxiliary processor 1523 (e.g., a graphics processing unit (GPU), a neural processing unit (NPU), an image signal processor (ISP), a sensor hub processor, or a communication processor (CP)) that is operable independently from, or in conjunction with, the main processor 1521. For example, when the electronic device 1501 includes the main processor 1521 and the auxiliary processor 1523, the auxiliary processor 1523 may be adapted to consume less power than the main processor 1521, or to be specific to a specified function. The auxiliary processor 1523 may be implemented as separate from, or as part of the main processor 1521.

The auxiliary processor 1523 may control at least some of functions or states related to at least one component (e.g., the display module 1560, the sensor module 1576, or the communication module 1590) among the components of the electronic device 1501, instead of the main processor 1521 while the main processor 1521 is in an inactive (e.g., sleep) state, or together with the main processor 1521 while the main processor 1521 is in an active state (e.g., executing an application). According to an embodiment, the auxiliary processor 1523 (e.g., an image signal processor or a communication processor) may be implemented as part of another component (e.g., the camera module 1580 or the communication module 1590) functionally related to the auxiliary processor 1523. According to an embodiment, the auxiliary processor 1523 (e.g., the neural processing unit) may include a hardware structure specified for artificial intelligence model processing. An artificial intelligence model may be generated by machine learning. Such learning may be performed, e.g., by the electronic device 1501 where the artificial intelligence is performed or via a separate server (e.g., the server 1508). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1530 may store various data used by at least one component (e.g., the processor 1520 or the sensor module 1576) of the electronic device 1501. The various data may include, for example, software (e.g., the program 1540) and input data or output data for a command related thereto. The memory 1530 may include the volatile memory 1532 or the non-volatile memory 1534.

The program 1540 may be stored in the memory 1530 as software, and may include, for example, an operating system (OS) 1542, middleware 1544, or an application 1546.

The input module 1550 may receive a command or data to be used by another component (e.g., the processor 1520) of the electronic device 1501, from the outside (e.g., a user) of the electronic device 1501. The input module 1550 may include, for example, a microphone, a mouse, a keyboard, a key (e.g., a button), or a digital pen (e.g., a stylus pen).

The sound output module 1555 may output sound signals to the outside of the electronic device 1501. The sound output module 1555 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1560 may visually provide information to the outside (e.g., a user) of the electronic device 1501. The display module 1560 may include, for example, a display, a hologram device, or a projector and control circuitry to control a corresponding one of the display, hologram device, and projector. According to an embodiment, the display module 1560 may include a touch sensor adapted to detect a touch, or a pressure sensor adapted to measure the intensity of force incurred by the touch.

The audio module 1570 may convert a sound into an electrical signal and vice versa. According to an embodiment, the audio module 1570 may obtain the sound via the input module 1550, or output the sound via the sound output module 1555 or a headphone of an external electronic device (e.g., an electronic device 1502) directly (e.g., wiredly) or wirelessly coupled with the electronic device 1501.

The sensor module 1576 may detect an operational state (e.g., power or temperature) of the electronic device 1501 or an environmental state (e.g., a state of a user) external to the electronic device 1501, and then generate an electrical signal or data value corresponding to the detected state. According to an embodiment, the sensor module 1576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1577 may support one or more specified protocols to be used for the electronic device 1501 to be coupled with the external electronic device (e.g., the electronic device 1502) directly (e.g., wiredly) or wirelessly. According to an embodiment, the interface 1577 may include, for example, a high definition multimedia interface (HDMI), a universal serial bus (USB) interface, a secure digital (SD) card interface, or an audio interface.

A connecting terminal 1578 may include a connector via which the electronic device 1501 may be physically connected with the external electronic device (e.g., the electronic device 1502). According to an embodiment, the connecting terminal 1578 may include, for example, an HDMI connector, a USB connector, a SD card connector, or an audio connector (e.g., a headphone connector).

The haptic module 1579 may convert an electrical signal into a mechanical stimulus (e.g., a vibration or a movement) or electrical stimulus which may be recognized by a user via his tactile sensation or kinesthetic sensation. According to an embodiment, the haptic module 1579 may include, for example, a motor, a piezoelectric element, or an electric stimulator.

The camera module 1580 may capture a still image or moving images. According to an embodiment, the camera module 1580 may include one or more lenses, image sensors, image signal processors, or flashes.

The power management module 1588 may manage power supplied to the electronic device 1501. According to an embodiment, the power management module 1588 may be implemented as at least part of, for example, a power management integrated circuit (PMIC).

The battery 1589 may supply power to at least one component of the electronic device 1501. According to an embodiment, the battery 1589 may include, for example, a primary cell which is not rechargeable, a secondary cell which is rechargeable, or a fuel cell.

The communication module 1590 may support establishing a direct (e.g., wired) communication channel or a wireless communication channel between the electronic device 1501 and the external electronic device (e.g., the electronic device 1502, the electronic device 1504, or the server 1508) and performing communication via the established communication channel. The communication module 1590 may include one or more communication processors that are operable independently from the processor 1520 (e.g., the application processor (AP)) and supports a direct (e.g., wired) communication or a wireless communication. According to an embodiment, the communication module 1590 may include a wireless communication module 1592 (e.g., a cellular communication module, a short-range wireless communication module, or a global navigation satellite system (GNSS) communication module) or a wired communication module 1594 (e.g., a local area network (LAN) communication module or a power line communication (PLC) module). A corresponding one of these communication modules may communicate with the external electronic device via the first network 1598 (e.g., a short-range communication network, such as Bluetooth™, wireless-fidelity (Wi-Fi) direct, or infrared data association (IrDA)) or the second network 1599 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1592 may identify and authenticate the electronic device 1501 in a communication network, such as the first network 1598 or the second network 1599, using subscriber information (e.g., international mobile subscriber identity (IMSI)) stored in the subscriber identification module 1596.

The wireless communication module 1592 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1592 may support a high-frequency band (e.g., the mmWave band) to achieve, e.g., a high data transmission rate. The wireless communication module 1592 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1592 may support various requirements specified in the electronic device 1501, an external electronic device (e.g., the electronic device 1504), or a network system (e.g., the second network 1599). According to an embodiment, the wireless communication module 1592 may support a peak data rate (e.g., 20 Gbps or more) for implementing eMBB, loss coverage (e.g., 1564 dB or less) for implementing mMTC, or U-plane latency (e.g., 0.5 ms or less for each of downlink (DL) and uplink (UL), or a round trip of 15 ms or less) for implementing URLLC.

The antenna module 1597 may transmit or receive a signal or power to or from the outside (e.g., the external electronic device) of the electronic device 1501. According to an embodiment, the antenna module 1597 may include an antenna including a radiating element composed of a conductive material or a conductive pattern formed in or on a substrate (e.g., a printed circuit board (PCB)). According to an embodiment, the antenna module 1597 may include a plurality of antennas (e.g., array antennas). In such a case, at least one antenna appropriate for a communication scheme used in the communication network, such as the first network 1598 or the second network 1599, may be selected, for example, by the communication module 1590 (e.g., the wireless communication module 1592) from the plurality of antennas. The signal or the power may then be transmitted or received between the communication module 1590 and the external electronic device via the selected at least one antenna. According to an embodiment, another component (e.g., a radio frequency integrated circuit (RFIC)) other than the radiating element may be additionally formed as part of the antenna module 1597.

According to various embodiments, the antenna module 1597 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1501 and the external electronic device 1504 via the server 1508 coupled with the second network 1599. Each of the electronic devices 1502 or 1504 may be a device of a same type as, or a different type, from the electronic device 1501. According to an embodiment, all or some of operations to be executed at the electronic device 1501 may be executed at one or more of the external electronic devices 1502, 1504, or 1508. For example, if the electronic device 1501 should perform a function or a service automatically, or in response to a request from a user or another device, the electronic device 1501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1501. The electronic device 1501 may provide the outcome, with or without further processing of the outcome, as at least part of a reply to the request. To that end, a cloud computing, distributed computing, mobile edge computing (MEC), or client-server computing technology may be used, for example. The electronic device 1501 may provide ultra low-latency services using, e.g., distributed computing or mobile edge computing. In another embodiment, the external electronic device 1504 may include an internet-of-things (IoT) device. The server 1508 may be an intelligent server using machine learning and/or a neural network. According to an embodiment, the external electronic device 1504 or the server 1508 may be included in the second network 1599. The electronic device 1501 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1540) including one or more instructions that are stored in a storage medium (e.g., internal memory 1536 or external memory 1538) that is readable by a machine (e.g., the electronic device 1501). For example, a processor (e.g., the processor 1520) of the machine (e.g., the electronic device 1501) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

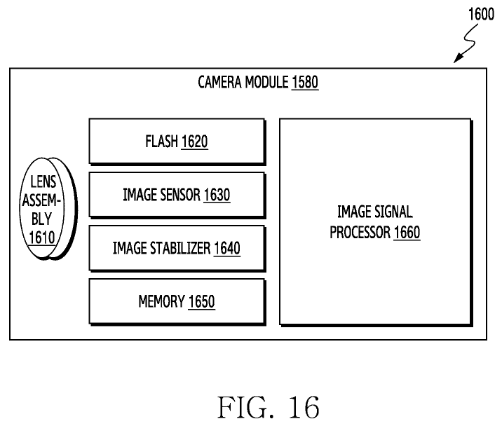

FIG. 16 is a block diagram illustrating a camera module according to various embodiments.

Referring to FIG. 16, the camera module 1580 may include a lens assembly 1610, a flash 16160, an image sensor 1630, an image stabilizer 1640, memory 1650 (e.g., buffer memory), or an image signal processor 1660. The lens assembly 1610 may collect light emitted or reflected from an object whose image is to be taken. The lens assembly 1610 may include one or more lenses. According to an embodiment, the camera module 1580 may include a plurality of lens assemblies 1610. In such a case, the camera module 1580 may form, for example, a dual camera, a 360-degree camera, or a spherical camera. Some of the plurality of lens assemblies 1610 may have the same lens attribute (e.g., view angle, focal length, auto-focusing, f number, or optical zoom), or at least one lens assembly may have one or more lens attributes different from those of another lens assembly. The lens assembly 1610 may include, for example, a wide-angle lens or a telephoto lens.

The flash 16160 may emit light that is used to reinforce light reflected from an object. According to an embodiment, the flash 16160 may include one or more light emitting diodes (LEDs) (e.g., a red-green-blue (RGB) LED, a white LED, an infrared (IR) LED, or an ultraviolet (UV) LED) or a xenon lamp. The image sensor 1630 may obtain an image corresponding to an object by converting light emitted or reflected from the object and transmitted via the lens assembly 1610 into an electrical signal. According to an embodiment, the image sensor 1630 may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor 1630 may be implemented using, for example, a charged coupled device (CCD) sensor or a complementary metal oxide semiconductor (CMOS) sensor.

The image stabilizer 1640 may move the image sensor 1630 or at least one lens included in the lens assembly 1610 in a particular direction, or control an operational attribute (e.g., adjust the read-out timing) of the image sensor 1630 in response to the movement of the camera module 1580 or the electronic device 1501 including the camera module 1580. This allows compensating for at least part of a negative effect (e.g., image blurring) by the movement on an image being captured. According to an embodiment, the image stabilizer 1640 may sense such a movement by the camera module 1580 or the electronic device 1501 using a gyro sensor (not shown) or an acceleration sensor (not shown) disposed inside or outside the camera module 1580. According to an embodiment, the image stabilizer 1640 may be implemented, for example, as an optical image stabilizer.

The memory 1650 may store, at least temporarily, at least part of an image obtained via the image sensor 1630 for a subsequent image processing task. For example, if image capturing is delayed due to shutter lag or multiple images are quickly captured, a raw image obtained (e.g., a Bayer-patterned image, a high-resolution image) may be stored in the memory 1650, and its corresponding copy image (e.g., a low-resolution image) may be previewed via the display module 160. Thereafter, if a specified condition is met (e.g., by a user's input or system command), at least part of the raw image stored in the memory 1650 may be obtained and processed, for example, by the image signal processor 1660. According to an embodiment, the memory 1650 may be configured as at least part of the memory 1530 or as a separate memory that is operated independently from the memory 1530.

The image signal processor 1660 may perform one or more image processing with respect to an image obtained via the image sensor 1630 or an image stored in the memory 1650. The one or more image processing may include, for example, depth map generation, three-dimensional (3D) modeling, panorama generation, feature point extraction, image synthesizing, or image compensation (e.g., noise reduction, resolution adjustment, brightness adjustment, blurring, sharpening, or softening). Additionally or alternatively, the image signal processor 1660 may perform control (e.g., exposure time control or read-out timing control) with respect to at least one (e.g., the image sensor 1630) of the components included in the camera module 1580. An image processed by the image signal processor 1660 may be stored back in the memory 1650 for further processing, or may be provided to an external component (e.g., the memory 1530, the display module 1560, the electronic device 1501, the electronic device 1504, or the server 1508) outside the camera module 1580. According to an embodiment, the image signal processor 1660 may be configured as at least part of the processor 1520, or as a separate processor that is operated independently from the processor 1520. If the image signal processor 1660 is configured as a separate processor from the processor 1520, at least one image processed by the image signal processor 1660 may be displayed, by the processor 1520, via the display module 1560 as it is or after being further processed.

According to an embodiment, the electronic device 1501 may include a plurality of camera modules 1580 having different attributes or functions. In such a case, at least one of the plurality of camera modules 1580 may form, for example, a wide-angle camera and at least another of the plurality of camera modules 1580 may form a telephoto camera. Similarly, at least one of the plurality of camera modules 1580 may form, for example, a front camera and at least another of the plurality of camera modules 1580 may form a rear camera.

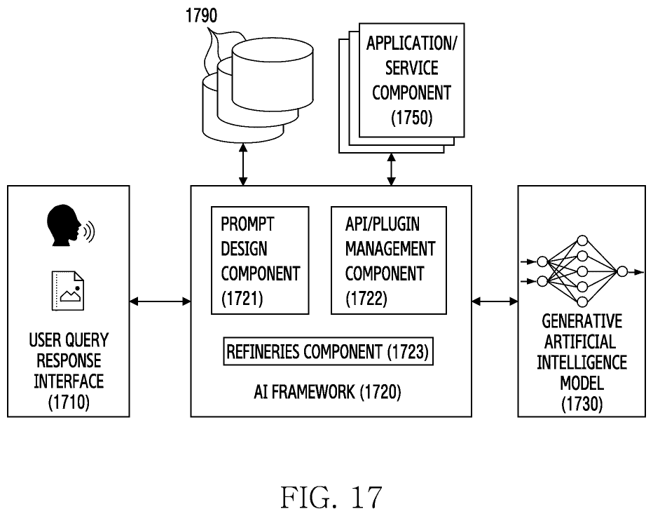

FIG. 17 is a schematic diagram of an exemplary AI system.

Referring to FIG. 17, an AI system 1700 may include an input/output interface 1710, an artificial intelligence (AI) framework 1720, a generative AI model 1730, an application/service component 1780, and/or a knowledge repository 1790.

The input/output interface 1710 may receive an input. The input may include data obtained or generated by a user input and/or an electronic device (e.g., the electronic device 100 or the electronic device 1501 described above). The data may include an image, a video, and/or sensor data (e.g., sensor or sensor Hub (e.g., illuminance data around the electronic device obtained from the auxiliary processor 1523, posture data (or orientation data)) of the electronic device, the temperature inside the electronic device (e.g., the temperature of the display 320 or the temperature of the at least one processor 300), size information of the display area of the display 320 and/or an image obtained through the image sensor (e.g., included in the camera module 1580) of the electronic device) generated by at least one processor (e.g., at least one processor 300 or a processor 1520) of the electronic device. The user input may include natural language, touch data obtained through a touch circuit (e.g., used to identify an input from a finger and/or a stylus) included in a display panel, an image and/or a video displayed (and/or to be displayed) on the display panel. As a non-limiting example, the user input may be received by the input/output interface 1710 together with context information. The context information may be described as additional information obtained in relation to the user input. The context information may be related to a state (e.g., including a state of the electronic device and/or a state (e.g., a user state) around the electronic device) when the user input is received. For example, the context information may include information on one or more software applications executed in the electronic device when the user input is received. For example, the context information may include information on a position of the electronic device (or a position of a user of the electronic device) when the user input is received. For example, the user input may be integrated with the context information. For example, the user input integrated with the context information may be received as the input by the input/output interface 1710.

The input/output interface 1710 may transmit (or provide) an output. The output may include a result (or result information) generated or obtained by the AI system 1700, based at least in part on the input. A format of the output may vary. For example, the output may include natural language. For example, the output may include content (e.g., including media content and/or multimedia content). For example, the output may include an action related to the user of the electronic device. For example, the output may have a format according to a user setting of the electronic device.

The input/output interface 1710 may be described as a user query/response interface.

The AI framework 1720 may be used to obtain information (or data) on the input from the input/output interface 1710, and control one or more components related to the AI system 1700 using the obtained information.

For example, a prompt design component 1721 in the AI framework 1720 may generate or obtain a prompt for the generative AI model 1730 (e.g., including a large language model (LLM) or a large multimodal model (LMM)) using the obtained information. For example, the prompt design component 1721 may be described as an AI component that uses a learning algorithm and/or a neural network to provide a reinforced prompt over time. For example, the prompt design component 1721 may generate or obtain a prompt by accessing a knowledge component (e.g., the knowledge repository 1790) including user preference data, a prompt library, and/or a prompt example, using the obtained information. The generated prompt may be provided to the generative AI model 1730 (e.g., including the LLM or the LMM).

For example, an API/plug-in management component 1722 in the AI framework 1720 may be used to support communication for additional information requested (or caused) in relation to the prompt provided (or to be provided) to the generative AI model 1730. For example, the API/plug-in management component 1722 may be used to generate or establish a channel for communication with various data sources (e.g., the knowledge repository 1790). For example, the API/plug-in management component 1722 may support access to at least some of the data sources. For example, the API/plug-in management component 1722 may be used to request another component (e.g., the application/service component 1780) that performs feedback (or response) according to the prompt. As a non-limiting example, information obtained (or generated) through the API/plug-in management component 1722 may be provided to the prompt design component 1721 for generation of the prompt. As a non-limiting example, the information obtained (or generated) through the API/plug-in management component 1722 may be provided to the generative AI model 1730.

For example, an improvement component 1723 in the AI framework 1720 may at least partially tune (or adjust) (or change) a result (e.g., content) obtained (or outputted) from the generative AI model 1730. For example, the improvement component 1723 may determine or verify whether the content obtained from the generative AI model 1730 is related to the input. For example, the improvement component 1723 may determine or verify whether the content obtained from the generative AI model 1730 includes biased content. For example, the improvement component 1723 may determine or verify whether the content obtained from the generative AI model 1730 includes harmful content. For example, the improvement component 1723 may support or assist in performing additional processing to improve the content obtained from the generative AI model 1730. For example, the improvement component 1723 may support providing a hint to the user to improve the content.

The generative AI model 1730 may be described as an artificial intelligence neural network that generates feedback in response to a prompt. For example, the feedback is related to the prompt, but may further include additional data and/or information relative to the prompt. For example, the feedback may include new content relative to the prompt. For example, the generative AI model 1730 may include a model generating an image and/or a model generating language. For example, the model that generates an image may include a generative adversarial network (GAN) and/or a variational auto encoder (VAE). For example, the model that generates an image may include a diffusion-based generative model (e.g., a transformer VAE). For example, the model that generates language may include a CHAT-GPT 3 and/or a CHAT-GPT 4. For example, the generative AI model 1730 may include the LMM that generates the feedback by recognizing text, an image, and/or a voice.

As a non-limiting example, the AI framework 1720 and/or the generative AI model 1730 may be included in an AI module (e.g., including a processing circuitry) in the electronic device. For example, the AI module may be operatively coupled to at least one processor (e.g., the at least one processor 300 or the processor 1520) of the electronic device. For example, the AI module may be operatively coupled to a display driving circuit of the electronic device. For example, the AI module may be operatively coupled to a sensor hub of the electronic device for one or more sensors in the electronic device.

The technical problems to be achieved in this document are not limited to those described above, and other technical problems not mentioned herein will be clearly understood by those having ordinary knowledge in the art to which the disclosure belongs.

As described above, the electronic device (e.g., the electronic device 100 of FIG. 3) may comprise memory (e.g., the memory 310 of FIG. 3), comprising one or more storage mediums, storing instructions, and at least one processor (e.g., the at least one processor 300 of FIG. 3) comprising processing circuitry. The electronic device may comprise a first camera (e.g., the first camera 105 of FIG. 3) having a first field of view (FOV) (e.g., the first field of view 125 of FIG. 1), a second camera (e.g., the second camera 110 of FIG. 3) having a second FOV (e.g., the second field of view 130 of FIG. 1) wider than the first FOV, and a display (e.g., the display 320 of FIG. 3). The second camera and the first camera may be disposed on a same side of the electronic device to face in a same direction. The instructions may, when executed by the at least one processor individually or collectively, cause the electronic device to receive an input for obtaining an image through the first camera. The instructions may, when executed by the at least one processor individually or collectively, cause the electronic device to, based on the input, control the first camera to obtain a first image (e.g., the first image 500 of FIG. 5A). The instructions may, when executed by the at least one processor individually or collectively, cause the electronic device to, based on the input, control the second camera to obtain a second image (e.g., the second image 520 of FIG. 5A). The instructions may, when executed by the at least one processor individually or collectively, cause the electronic device to obtain a third image, by compensating for a peripheral area of the obtained first image using the obtained second image. The instructions may, when executed by the at least one processor individually or collectively, cause the electronic device to store, in the memory, the third image (e.g., the third image 610 of FIG. 6).

For example, the instructions may, when executed by the at least one processor individually or collectively, cause the electronic device to, based on obtaining the second image, identify a partial image of the second image, corresponding to the peripheral area of the first image. The instructions may, when executed by the at least one processor individually or collectively, cause the electronic device to perform an operation to compensate for a deteriorated characteristic of the first image, using the first image and the partial image of the second image. The instructions may, when executed by the at least one processor individually or collectively, cause the electronic device to obtain the third image based on the operation performed. For example, the instructions may, when executed by the at least one processor individually or collectively, cause the electronic device to perform the operation compensating for the deteriorated characteristic of the first image, by providing the first image and the partial image of the second image to a model trained to compensate for a deteriorated characteristic of an image. The instructions may, when executed by the at least one processor individually or collectively, cause the electronic device to obtain the third image from the trained model.

For example, the instructions may, when executed by the at least one processor individually or collectively, cause the electronic device to, before receiving the input, control the first camera to obtain a fourth image having a second resolution that is smaller than a first resolution of the first image. The instructions may, when executed by the at least one processor individually or collectively, cause the electronic device to, before receiving the input, control the second camera to obtain a fifth image having a fourth resolution that is smaller than a third resolution of the second image. The instructions may, when executed by the at least one processor individually or collectively, cause the electronic device to, based on obtaining the fifth image, identify a partial image of the fifth image, corresponding to a peripheral area of the third image. The instructions may, when executed by the at least one processor individually or collectively, cause the electronic device to perform an operation to compensate for a deteriorated characteristic of the fourth image using the fourth image and the partial image of the fifth image. The instructions may, when executed by the at least one processor individually or collectively, cause the electronic device to display a sixth image, obtained based on performance of the operation to compensate for the deteriorated characteristic of the fourth image, on the display as a preview image.

For example, the instructions may, when executed by the at least one processor individually or collectively, cause the electronic device to control the first camera to obtain a first set of image, including the first image, based on the input received in a continuous mode. The instructions may, when executed by the at least one processor individually or collectively, cause the electronic device to perform an operation to compensate for a deteriorated characteristic of the images in the first set of image using the first set of image and the partial image of the second image. The instructions may, when executed by the at least one processor individually or collectively, cause the electronic device to store a second set of image including other images, obtained based on performance of the operation to compensate for the deteriorated characteristic of the images in the first set of image and corresponding to each of the images included in the first set of image, in the memory.

For example, the instructions may, when executed by the at least one processor individually or collectively, cause the electronic device to store a file in the memory, including the second set of image.

For example, the instructions may, when executed by the at least one processor individually or collectively, cause the electronic device to, based on the input, received in a video mode, control the first camera to obtain a first set of image including the first image. The instructions may, when executed by the at least one processor individually or collectively, cause the electronic device to, based on the input, received in the video mode, control the second camera to obtain a second set of image including the second image. The instructions may, when executed by the at least one processor individually or collectively, cause the electronic device to identify partial images each of images in the second set of image including the partial image. The partial images may correspond to peripheral areas of other images in the first set of image. The instructions may, when executed by the at least one processor individually or collectively, cause the electronic device to perform an operation to compensate for a deteriorated characteristic of the other images in the first set of image using the first set of image and the partial images. The instructions may, when executed by the at least one processor individually or collectively, cause the electronic device to store a video including a third set of image obtained based on performance of the operation to compensate for the deteriorated characteristic of the other images in the first set of image in the memory.

For example, the deteriorated characteristic of the first image may include a deteriorated characteristic related to relative illumination, a deteriorated characteristic related to gradation, and/or a deteriorated characteristic by barrel distortion.

For example, the instructions may, when executed by the at least one processor individually or collectively, cause the electronic device to, in a normal mode, display an executable object for switching a mode on the display. The instructions may, when executed by the at least one processor individually or collectively, cause the electronic device to, based on the input for the executable object, switch from the normal mode to a mode for obtaining the third image. The instructions may, when executed by the at least one processor individually or collectively, cause the electronic device to receive the input, in the mode for obtaining the third image.

The method as above-described may be performed in an electronic device comprising memory, comprising one or more storage mediums, storing instructions, a first camera having a first field of view (FOV), a second camera having a second FOV wider than the first FOV, and a display. The second camera 110 and the first camera 105 may be disposed on a same side of the electronic device to face in a same direction. The method may comprise receiving an input for obtaining an image through the first camera. The method may comprise, based on the input, controlling the first camera to obtain a first image. The method may comprise, based on the input, controlling the second camera to obtain a second image. The method may comprise obtaining a third image, by compensating for a peripheral area of the first image using the second image. The method may comprise storing, in the memory, the third image.

For example, the method may comprise, based on obtaining the second image, identifying a partial image of the second image, corresponding to the peripheral area of the first image. The method may comprise performing an operation to compensate for a deteriorated characteristic of the first image, using the first image and the partial image of the second image. The method may comprise obtaining the third image based on the operation performed. For example, the method may comprise performing the operation compensating for the deteriorated characteristic of the first image, by providing the first image and the partial image of the second image to a model trained to compensate for a deteriorated characteristic of an image. The method may comprise obtaining the third image from the trained model. For example, the method may comprise, before receiving the input, controlling the first camera to obtain a fourth image having a second resolution that is smaller than a first resolution of the first image. The method may comprise, before receiving the input, controlling the second camera to obtain a fifth image having a fourth resolution that is smaller than a third resolution of the second image. The method may comprise, based on obtaining the fifth image, identifying a partial image of the fifth image, corresponding to a peripheral area of the third image. The method may comprise performing an operation to compensate for a deteriorated characteristic of the fourth image using the fourth image and the partial image of the fifth image. The method may comprise displaying a sixth image, obtained based on performance of the operation to compensate for the deteriorated characteristic of the fourth image, on the display as a preview image.

For example, the method may comprise controlling the first camera to obtain a first set of image, including the first image, based on the input received in a continuous mode. The method may comprise performing an operation to compensate for a deteriorated characteristic of images in the first set of image using the first set of image and the partial image of the second image. The method may comprise storing a second set of image, obtained based on performance of the operation to compensate for the deteriorated characteristic of the images in the first set of image and corresponding to each of the images in the first set of image, in the memory.

For example, the method may comprise storing a file in the memory, including the second set of image.

For example, the method may comprise, based on the input, received in a video mode, controlling the first camera to obtain a first set of image including the first image. The method may comprise, based on the input, received in the video mode, controlling the second camera to obtain a second set of image including the second image. The method may comprise identifying partial images each of images in the second set of image including the partial image. The partial images may correspond to peripheral areas of other images in the first set of image. The method may comprise performing an operation to compensate for a deteriorated characteristic of the other images in the first set of image using the first set of image and the partial images. The method may comprise storing a video comprising a third set of image obtained based on performance of the operation to compensate for the deteriorated characteristic of the other images in the first set of image in the memory.

For example, the deteriorated characteristic of the first image may include a deteriorated characteristic related to relative illumination, a deteriorated characteristic related to gradation, and/or a deteriorated characteristic by barrel distortion.

For example, the method may comprise, in a normal mode, displaying an executable object for switching a mode on the display. The method may comprise, based on an input for the executable object, switching from the normal mode to a mode for obtaining the third image. The method may comprise receiving the input, in the mode for obtaining the third image.

As described above, a non-transitory computer readable storage medium may store one or more programs. The one or more programs may comprise instructions which, when executed by an electronic device comprising memory, comprising one or more storage mediums, storing instructions, a first camera having a first field of view (FOV), a second camera having a second FOV wider than the first FOV, wherein the second camera 110 and the first camera 105 are disposed on a same side of the electronic device to face in a same direction, and a display, cause the electronic device to receive an input for obtaining an image through the first camera. The one or more programs may comprise instructions which, when executed by the electronic device, based on the input, cause the electronic device to control the first camera to obtain a first image. The one or more programs may comprise instructions which, when executed by the electronic device, based on the input, cause the electronic device to control the second camera to obtain a second image. The one or more programs may comprise instructions which, when executed by the electronic device, cause the electronic device to obtain a third image, by compensating for a peripheral area of the first image using the second image. The one or more programs may comprise instructions which, when executed by the electronic device, cause the electronic device to store, in the memory, the third image.

For example, the one or more programs may comprise instructions to, when executed by the electronic device, cause the electronic device to, based on obtaining the second image, identify a partial image of the second image, corresponding to the peripheral area of the first image. The one or more programs may comprise instructions to, when executed by the electronic device, cause the electronic device to perform an operation to compensate for a deteriorated characteristic of the first image, using the first image and the partial image of the second image. The one or more programs may comprise instructions to, when executed by the electronic device, cause the electronic device to obtain the third image based on the operation performed.

For example, the one or more programs may comprise instructions to, when executed by the electronic device, cause the electronic device to perform the operation compensating for the deteriorated characteristic of the first image, by providing the first image and the partial image of the second image to a model trained to compensate for a deteriorated characteristic of an image. The one or more programs may comprise instructions to, when executed by the electronic device, cause the electronic device to obtain the third image from the trained model. For example, the one or more programs may comprise instructions to, when executed by the electronic device, cause the electronic device to, before receiving the input, control the first camera to obtain a fourth image having a second resolution that is smaller than a first resolution of the first image. The one or more programs may comprise instructions to, when executed by the electronic device, cause the electronic device to, before receiving the input, control the second camera to obtain a fifth image having a fourth resolution that is smaller than a third resolution of the second image. The one or more programs may comprise instructions to, when executed by the electronic device, cause the electronic device to, based on obtaining the fifth image, identify a partial image of the fifth image, corresponding to a peripheral area of the third image. The one or more programs may comprise instructions to, when executed by the electronic device, cause the electronic device to perform an operation to compensate for a deteriorated characteristic of the fourth image using the fourth image and the partial image of the fifth image. The one or more programs may comprise instructions to, when executed by the electronic device, cause the electronic device to display a sixth image, obtained based on performance of the operation to compensate for the deteriorated characteristic of the fourth image, on the display as a preview image.

For example, the one or more programs may comprise instructions to, when executed by the electronic device, cause the electronic device to control the first camera to obtain a first set of image, including the first image, based on the input received in a continuous mode. The one or more programs may comprise instructions to, when executed by the electronic device, cause the electronic device to perform an operation to compensate for a deteriorated characteristic of the images in the first set of image using the first set of image and the partial image of the second image. The one or more programs may comprise instructions to, when executed by the electronic device, cause the electronic device to store a second set of image, obtained based on performance of the operation to compensate for a deteriorated characteristic of the images in the first set of image and corresponding to each of the images in the first set of image, in the memory.

For example, the one or more programs may comprise instructions to, when executed by the electronic device, cause the electronic device to store a file in the memory, including the second set of image.

For example, the one or more programs may comprise instructions to, when executed by the electronic device, cause the electronic device to, based on the input, received in a video mode, control the first camera to obtain a first set of image including the first image. The one or more programs may comprise instructions to, when executed by the electronic device, cause the electronic device to, based on the input, received in the video mode, control the second camera to obtain a second set of image including the second image. The one or more programs may comprise instructions to, when executed by the electronic device, cause the electronic device to identify partial images each of images in the second set of image including the partial image. The partial images may correspond to peripheral areas of other images in the first set of image. The one or more programs may comprise instructions to, when executed by the electronic device, cause the electronic device to perform an operation to compensate for a deteriorated characteristic of the other images in the first set of image using the first set of image and the partial images. The one or more programs may comprise instructions to, when executed by the electronic device, cause the electronic device to store a video including a third set of image obtained based on performance of the operation to compensate for the deteriorated characteristic of the other images in the first set of image in the memory.

For example, the deteriorated characteristic of the first image may include a deteriorated characteristic related to relative illumination, a deteriorated characteristic related to gradation, and/or a deteriorated characteristic by barrel distortion.

For example, the one or more programs may comprise instructions to, when executed by the electronic device, cause the electronic device to, in a normal mode, display an executable object for switching a mode on the display. The one or more programs may comprise instructions to, when executed by the electronic device, cause the electronic device to, based on an input for the executable object, switch from the normal mode to a mode for obtaining the third image. The one or more programs may comprise instructions to, when executed by the electronic device, cause the electronic device to receive the input, in the mode for obtaining the third image.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

The effects that can be obtained from the present disclosure are not limited to those described above, and any other effects not mentioned herein will be clearly understood by those having ordinary knowledge in the art to which the present disclosure belongs.

No claim element is to be construed under the provisions of 35 U.S.C. § 112, sixth paragraph, unless the element is expressly recited using the phrase “means for” or “means”.

What is claimed is:

1. An electronic device comprising:
memory, comprising one or more storage mediums, storing instructions;
a first camera having a first field of view (FOV);
a second camera having a second FOV wider than the first FOV, wherein the second camera and the first camera are disposed on a same side of the electronic device to face in a same direction;
a display; and
at least one processor comprising processing circuitry,
wherein the instructions, when executed by the at least one processor individually or collectively, cause the electronic device to:
receive an input for obtaining an image through the first camera,
based on the input:
control the first camera to obtain a first image, and
control the second camera to obtain a second image,
obtain a third image, by compensating for a peripheral area of obtained first image using the obtained second image, and
store, in the memory, the third image.

2. The electronic device of claim 1, wherein the instructions, when executed by the at least one processor individually or collectively, cause the electronic device to:
based on obtaining the second image, identify a partial image of the second image, corresponding to the peripheral area of the first image,
perform an operation to compensate for a deteriorated characteristic of the first image, using the first image and the partial image of the second image, and
obtain the third image based on the operation performed.

3. The electronic device of claim 2, wherein the instructions, when executed by the at least one processor individually or collectively, cause the electronic device to:
perform the operation compensating for the deteriorated characteristic of the first image, by providing the first image and the partial image of the second image to a model trained to compensate for a deteriorated characteristic of an image, and
obtain the third image from the trained model.

4. The electronic device of claim 1,
wherein the instructions, when executed by the at least one processor individually or collectively, cause the electronic device to:
before receiving the input:
control the first camera to obtain a fourth image having a second resolution that is smaller than a first resolution of the first image, and
control the second camera to obtain a fifth image having a fourth resolution that is smaller than a third resolution of the second image, and
based on obtaining the fifth image, identify a partial image of the fifth image, corresponding to a peripheral area of the third image,
perform an operation to compensate for a deteriorated characteristic of the fourth image using the fourth image and the partial image of the fifth image, and
display a sixth image, obtained based on performance of the operation to compensate for the deteriorated characteristic of the fourth image, on the display as a preview image.

5. The electronic device of claim 2, wherein the instructions, when executed by the at least one processor individually or collectively, cause the electronic device to:
control the first camera to obtain a first set of image, including the first image, based on the input received in a continuous mode,
perform an operation to compensate for a deteriorated characteristic of the images in the first set of image using the first set of image and the partial image of the second image, and
store a second set of image including other images, obtained based on performance of the operation to compensate for the deteriorated characteristic of the images in the first set of image and corresponding to each of the images in the first set of image, in the memory.

6. The electronic device of claim 5, wherein the instructions, when executed by the at least one processor individually or collectively, cause the electronic device to:
store a file in the memory, including the second set of image.

7. The electronic device of claim 2, wherein the instructions, when executed by the at least one processor individually or collectively, cause the electronic device to:
based on the input, received in a video mode:
control the first camera to obtain a first set of image including the first image, and
control the second camera to obtain a second set of image including the second image, and
identify partial images each of images in the second set of image including the partial image, wherein the partial images correspond to peripheral areas of other images in the first set of image,
perform an operation to compensate for a deteriorated characteristic of the other images in the first set of image using the first set of image and the partial images, and
store a video including a third set of image obtained based on performance of the operation to compensate for the deteriorated characteristic of the other images in the first set of image, in the memory.

8. The electronic device of claim 2, wherein the deteriorated characteristic of the first image includes a deteriorated characteristic related to relative illumination, a deteriorated characteristic related to gradation, or a deteriorated characteristic by barrel distortion.

9. The electronic device of claim 1, wherein the instructions, when executed by the at least one processor individually or collectively, cause the electronic device to:
in a normal mode, display an executable object for switching a mode on the display,
based on the input for the executable object, switch from the normal mode to a mode for obtaining the third image, and
receive the input, in the mode for obtaining the third image.

10. A method executed in an electronic device comprising memory, comprising one or more storage mediums, storing instructions, a first camera having a first field of view (FOV), a second camera having a second FOV wider than the first FOV, wherein the second camera and the first camera are disposed on a same side of the electronic device to face in a same direction, and a display, the method comprising:
receiving an input for obtaining an image through the first camera;
based on the input:
controlling the first camera to obtain a first image; and
controlling the second camera to obtain a second image,
obtaining a third image, by compensating for a peripheral area of obtained first image using the obtained second image; and
storing, in the memory, the third image.

11. The method of claim 10, further comprising:
based on obtaining the second image, identifying a partial image of the second image, corresponding to the peripheral area of the first image;
performing an operation to compensate for a deteriorated characteristic of the first image, using the first image and the partial image of the second image; and
obtaining the third image based on the operation performed.

12. The method of claim 11, further comprising:
performing the operation compensating for the deteriorated characteristic of the first image, by providing the first image and the partial image of the second image to a model trained to compensate for a deteriorated characteristic of an image; and
obtaining the third image from the trained model.

13. The method of claim 10, further comprising:
before receiving the input:
controlling the first camera to obtain a fourth image having a second resolution that is smaller than a first resolution of the first image, and
controlling the second camera to obtain a fifth image having a fourth resolution that is smaller than a third resolution of the second image,
based on obtaining the fifth image, identifying a partial image of the fifth image, corresponding to a peripheral area of the third image;
performing an operation to compensate for a deteriorated characteristic of the fourth image using the fourth image and the partial image of the fifth image; and
displaying a sixth image, obtained based on performance of the operation to compensate for the deteriorated characteristic of the fourth image, on the display as a preview image.

14. The method of claim 11, further comprising:
controlling the first camera to obtain a first set of image, including the first image, based on the input received in a continuous mode;
performing an operation to compensate for a deteriorated characteristic of the images in the first set of image using the first set of image and the partial image of the second image; and
storing a second set of image including other images, obtained based on performance of the operation to compensate for the deteriorated characteristic of the images in the first set of image and corresponding to each of the images in the first set of image, in the memory.

15. The method of claim 14, further comprising:
storing a file in the memory, including the second set of image.

16. The method of claim 11, further comprising:
based on the input, received in a video mode:
controlling the first camera to obtain a first set of image including the first image, and
controlling the second camera to obtain a second set of image including the second image,
identifying partial images each of images in the second set of image including the partial image, wherein the partial images correspond to peripheral areas of other images in the first set of image;
performing an operation to compensate for a deteriorated characteristic of the other images in the first set of image using the first set of image and the partial images; and
storing a video including a third set of image obtained based on performance of the operation to compensate for the deteriorated characteristic of the other images in the first set of image, in the memory.

17. The method of claim 11, wherein the deteriorated characteristic of the first image includes at least one of a deteriorated characteristic related to relative illumination, a deteriorated characteristic related to gradation, or a deteriorated characteristic by barrel distortion.

18. The method of claim 10, further comprising:
in a normal mode, displaying an executable object for switching a mode on the display;
based on the input for the executable object, switching from the normal mode to a mode for obtaining the third image; and
receiving the input, in the mode for obtaining the third image.

19. A non-transitory computer readable storage medium storing one or more programs the one or more programs comprising instructions which, when executed by an electronic device comprising memory, comprising one or more storage mediums, storing instructions, a first camera having a first field of view (FOV), a second camera having a second FOV wider than the first FOV, wherein the second camera and the first camera are disposed on a same side of the electronic device to face in a same direction, and a display, cause the electronic device to:
receive an input for obtaining an image through the first camera;
based on the input:
control the first camera to obtain a first image; and
control the second camera to obtain a second image, and
obtaining a third image, by compensating for a peripheral area of the obtained first image using the obtained second image; and
store, in the memory, the third image.

20. The non-transitory computer readable storage medium of claim 19, wherein the one or more programs include instructions which, when executed by the electronic device, cause the electronic device to:
based on obtaining the second image, identify a partial image of the second image, corresponding to the peripheral area of the first image,
perform an operation to compensate for a deteriorated characteristic of the first image, using the first image and the partial image of the second image, and
obtain the third image based on the operation performed.
